(19) United States
(12) Patent Application Publication
(10) Pub. No.: US 2025/0276465 A1
(43) Pub. Date: Sep. 4, 2025

(54) CONSTRUCTION SITE MIXING MACHINE, MOBILE CONSTRUCTION SITE ROTARY MIXING MACHINE AND METHOD OF OPERATING THE CONSTRUCTION SITE MIXING MACHINE

(71) Applicant: Collomix GmbH, Gaimersheim (DE)

(72) Inventors: Alexander ESSING, Ingolstadt (DE); Herbert Buchberger, Pietenfeld (DE)

(21) Appl. No.: 19/069,539

(22) Filed: Mar. 4, 2025

(30) Foreign Application Priority Data
Mar. 4, 2024 (EP) 24161181.3
Jan. 10, 2025 (EP) 25151308.1

(51) Int. Cl. B28C 5/08; B28C 5/00; B28C 5/32; B28C 7/02; B28C 7/16

(52) U.S. Cl. CPC B28C 5/0831; B28C 5/006; B28C 5/32; B28C 7/02; B28C 7/162

(57) ABSTRACT

A construction site mixing machine for mixing mixing materials contains a mixing container for a mixing material, a mixing tool displacement device, by which a mixing tool is displaceable between a mixing tool use position and a mixing tool non-use position. The mixing tool displacement device has a telescoping device or is formed by such a telescoping device. The mixing tool is displaceable by the telescoping device between the mixing tool use position and the mixing tool non-use position. According to an alternative concept, a control unit is configured to drive the mixing container by the mixing container drive unit in the opposite direction to the mixing tool which is drivable in rotation by the mixing tool drive unit and/or that the control unit has a timer function by which the operating time of the mixing tool drive unit and/or the mixing container drive unit is settable.

### CROSS-REFERENCE TO RELATED APPLICATION

This application claims the priorities, under 35 U.S.C. § 119, of European Patent Applications EP 24161181.3, filed Mar. 4, 2024, and EP 25151308.1, filed Jan. 10, 2025; prior applications are herewith incorporated by reference in their entireties.

### FIELD AND BACKGROUND OF THE INVENTION

The invention relates to a construction site mixing machine, in particular a mobile construction site rotary mixing machine, for mixing materials, in particular for mixing plasters, screeds, concrete, mortar, slurries or resins.

Construction site mixing machines, especially mobile construction site mixing machines, such as construction site rotary mixing machines, play a major role on construction sites in order to efficiently and precisely mix a wide range of mixing materials on site, including plasters, screeds, concrete, mortar, slurries and resins, or the like. Their usually rotating mechanism enables homogeneous mixing of a wide variety of building materials, which leads to improved quality of the end products.

Construction site mixing machines, especially mobile construction site mixing machines, therefore enable the efficient production of mixing materials and are therefore effective high-performance machines for rough construction operations. In order to meet the increasing and changing requirements of the construction industry, there is a need to improve existing construction site mixing machines, especially in the areas of automation, material feed, user-friendliness and safety.

### SUMMARY OF THE INVENTION

It is therefore the object of the present invention to provide a construction site mixing machine, in particular a mobile construction site rotary mixing machine, for mixing materials, in particular for mixing plasters, screeds, concrete, mortars, slurries or resins, which meets the growing needs of the construction industry and is improved in particular with regard to user-friendliness and operational safety.

This problem is solved with the features of the independent mixing machine claim. Advantageous embodiments are the subject of the subclaims referring back to it.

According to the independent mixing machine claim, a construction site mixing machine, in particular a mobile construction site rotary mixing machine, is provided for mixing materials, in particular for mixing plasters, screeds, concrete, mortar, slurries or resins, which has an upwardly open mixing container which is suitable and designed to receive a mixing material in its receiving space. Furthermore, the construction site mixing machine comprises a mixing tool displacement device, by means of which at least one mixing tool, which can be actuated by means of a mixing tool drive unit and is preferably rotationally drivable, can be displaced between a preferably operational mixing tool use position, in which the at least one mixing tool is accommodated, preferably operationally, in the receiving space, and a mixing tool non-use position, in which the at least one mixing tool is not in any mixing tool use position, in particular in any operational mixing tool use position. According to the invention, it is provided that the mixing tool displacement device has a telescoping device, preferably arranged laterally next to the mixing container and/or projecting upwards in the vertical axis direction, or is formed by such a telescoping device, wherein the at least one mixing tool, preferably together with the mixing tool drive unit, can be displaced by means of the telescoping device between the at least one mixing tool use position and the mixing tool non-use position, as viewed in the telescopic axis direction.

A telescoping device of this type has significant advantages in terms of its adaptability, space saving and efficiency, especially compared to displacement devices that can be swiveled up and down. For example, a telescoping device enables particularly simple and variable adjustment of the respective mixing tool position in the telescopic axis direction. In addition, such telescoping devices can be arranged with less space requirement in the area of the mixing container holder. Furthermore, such telescoping devices are particularly easy and uncomplicated to handle and operate. In addition, such telescoping devices are characterized by a higher mechanical stability and thus a higher reliability. In the case of a telescoping device aligned in the vertical axis direction, the telescopic axis direction corresponds to the vertical axis direction.

According to a preferred specific embodiment, the telescoping device has at least two telescoping elements which can be telescoped relative to one another in the telescopic axis direction with respect to the telescoping device. In this context, a specific embodiment is particularly preferred in which the telescoping device has a lower telescoping element in the telescopic axis direction, which is adjoined, upwards in the telescopic axis direction, by at least one upper telescoping element which can be displaced relative thereto and on which the mixing tool drive unit, preferably together with the at least one mixing tool connected or connectable thereto, can be arranged or is arranged. It is particularly advantageous if the at least one mixing tool, in particular the free lower end of the at least one mixing tool, is located in a predetermined raised position, preferably in the area above the upper edge of the mixing container, in the extended position of the telescoping device and in the collapsed position of the telescoping device in the operational mixing tool use position. At this point, it should be expressly mentioned that the terms “top” and “bottom” in connection with a telescoping element always refer only to the relative position of two telescoping elements to one another and do not automatically mean that this must be a “bottom” or “top” telescoping element, let alone only two telescoping elements in total, although the latter is a particularly preferred, because compact, embodiment. In short, when the terms ‘top’ and ‘bottom’ are used in the context of the present invention in connection with a telescoping element, they always describe first of all only the relative positioning of two telescoping elements with respect to one another. They do not necessarily imply that one element is the ‘uppermost’ or ‘lowermost’, nor do they necessarily mean that the two telescoping elements must be directly adjacent to each other. One or more elements forming part of the telescoping device, in particular one or more telescoping elements, can also be arranged between the telescoping elements currently under consideration and/or below and/or above the telescoping elements currently under consideration.

According to a further alternative according to the invention, which is claimed both together and independently of the displacement device designed as a telescoping device, an upwardly open mixing container is provided, which is suitable and designed to receive a mixing material in its receiving space. Furthermore, a mixing tool displacement device, for example a telescoping device as a mixing tool displacement device, is provided, by means of which at least one mixing tool, which can be actuated by means of a mixing tool drive unit and is preferably rotationally drivable, can be displaced between at least one operational mixing tool use position, in which the at least one mixing tool is received in the receiving space ready for use, and a mixing tool non-use position, in which the at least one mixing tool is not in an operational mixing tool use position. Furthermore, a control unit is provided, which electronically controls the activation and deactivation of the mixing tool drive unit, and an actuation device is provided, by means of which the control unit can be activated and, if necessary, deactivated. The actuation device is preferably formed by a main switch acting as an on/off switch. In addition, it is provided that the control unit has a safety function and/or safety device which, i.e. safety function and/or safety device, is suitable and designed to enable operation of the mixing tool drive unit when the actuation device is activated, if the at least one mixing tool is in the operational mixing tool use position, or to block it if the at least one mixing tool is not in the operational mixing tool use position. A construction site mixing machine equipped in this way according to the invention offers a number of advantages that make it an efficient and safe solution for mixing various mixing materials: For example, the electronically controlled mixing tool drive unit ensures reliable and precise operation of the at least one mixing tool. Furthermore, the integrated safety function and/or safety device ensures safe operation of the mixing tool drive unit. It recognizes the correct position of the mixing tool and enables operation only in the operational mixing tool use position, which reduces or prevents potentially dangerous situations. The safety function and/or safety device can be implemented using a wide variety of technical measures. For example, the control unit can be equipped with position sensors as a safety device that detect whether the mixing tool is in the operational position or not. Alternatively or additionally, a safety switch could also be provided as a safety device, whereby the safety switch is activated when the mixing tool is brought into the operational position. This safety switch can be connected to the control unit and release operation when the correct position is reached. Finally, the safety function may alternatively or additionally be implemented in a programmable logic controller that takes into account various conditions and logics to safely enable or disable operation. These exemplary measures, which can be used individually or in combination, show that there are a wide variety of measures, i.e. mechanical and/or electronic interlocks in the broader sense, which can be used to physically and/or software-based ensure that operation is only enabled when the safety conditions are met.

In particular, in the event that the construction site mixer according to the invention is designed as a mobile construction site mixer, for example a mobile construction site rotary mixing machine, flexible use on construction sites of various types is ensured, as the construction site mixer can be placed on site regardless of the size or type of construction project, so that no external mixing stations are required. This helps to reduce time and transportation costs.

In summary, the construction site mixing machine according to the invention not only provides high performance and versatility in mixing different materials, but also ensures that the mixing process is operationally safe and precisely controlled to ensure high quality results on the construction site.

According to a particularly preferred specific embodiment, a mixing container holder is provided which holds the mixing container. This allows the mixing container to be positioned in a targeted manner and thus also ensures that the mixing container is in the correct desired position for the mixing task. For this purpose, the mixing container holder preferably has a flat or level support surface on which the mixing container can be placed in the mixing container holder. The support surface, in particular a flat or level support surface, of the mixing container holder enables simple and precise positioning of the mixing container. Construction workers can easily place the mixing container on the storage surface, which simplifies handling and makes the mixing machine ready for use quickly. In particular, the flat or level support surface also ensures a stable base for the mixing container during the mixing process. This contributes to even rotation and mixing of the materials by avoiding irregularities in the position of the mixing container.

According to a further particularly preferred embodiment, it can also be provided alternatively or additionally that the mixing container holder has a holding device which is suitable and configured to hold the mixing container, preferably the mixing container placed on the support surface, releasably on or on the mixing container holder, preferably releasably and non-positively and/or positively on or on the mixing container holder. In this context, the holding device can, for example, be formed by a clamping device which releasably clamps the mixing container, preferably a lower container area of the mixing container in relation to the vertical axis direction, by means of at least one clamping element. For example, the clamping device can be formed by a clamping ring or by several clamping elements, for example projecting from the mixing container holder in a bracket-like manner, which are arranged, for example, at a distance from each other around the support surface and clamp a lower edge area of the mixing container between them. However, according to a particularly preferred embodiment, which is also expressly claimed separately and independently of the embodiment of the mixing tool displacement device as a telescoping device, a positive-locking holding device can be provided, for example in such a way that at least one driver element is arranged on the mixing container holder, preferably in the area of the support surface of the mixing container holder, at least one engagement element is arranged which, in the position of use of the mixing container, i.e. with a mixing container positioned in or on the mixing container holder, interacts with at least one counter-engagement element formed on the mixing container, preferably on an underside of the mixing container, for example in the form of an engagement tab, which can be molded on there, for example. A specific embodiment is particularly preferred here, in which several engagement elements spaced apart from one another in the circumferential direction and/or several counter-engagement elements spaced apart from one another in the circumferential direction are provided, which ensures that the driver function acts quickly and reliably even when the mixing container drive unit reverses its direction of rotation. This ensures in a simple and reliable way that the mixing container can no longer slip during operation. A holding device of this type, in particular a force-locking and/or friction-locking device, provides a secure hold for the mixing container. This ensures stable positioning during the mixing process and minimizes possible vibrations and displacements of the mixing container. The holding device thus facilitates the secure attachment and removal of the mixing container from the mixing container holder. Construction workers can load and unload quickly and efficiently, which increases overall productivity.

According to a further particularly preferred embodiment of the construction site mixing machines according to the invention, it is provided that the mixing container receptacle has a rotatably mounted receiving element, preferably a rotary platform or rotary platform with a support surface for the mixing container, which receives the mixing container and is coupled to a mixing container drive unit so that it can be driven in rotation, so that the mixing container can be rotated together with the receiving element during the mixing process. A rotatably mounted receiving element ensures uniform rotation of the mixing container during the mixing process, which leads to homogeneous mixing of the materials and contributes significantly to improving the quality of the end product. In particular, uniform mixing of the materials is achieved when the mixing container and mixing tool rotate together. The continuous movement helps to ensure that all components of the mixture are effectively mixed together, resulting in a more homogeneous product quality. Simultaneous rotation during mixing also allows for more efficient mixing in less time, as the mixing material is not only moved through the mixing tool alone, but also through the rotating mixing container. In addition, the simultaneous rotation also helps to reduce the adhesion of materials to the mixing tool and the container walls in the case of many mixing materials. In addition, the rotation of the mixing container also allows the operating mode to be adapted more flexibly to different mixing materials. For example, depending on the properties of the materials to be mixed, the relative rotation between the mixing container and mixing tool can be varied to create the desired optimum mixing conditions.

The latter is achieved in particular with a preferred embodiment in which the control unit also electronically controls the activation and deactivation of the mixing container drive unit in an advantageous dual function. According to a particularly preferred embodiment in this respect, it can also be provided that the safety function and/or safety device is suitable and designed to enable operation of the mixing container drive unit when the actuation device is activated, if the at least one mixing tool is in the operational mixing tool use position, or to block it if the at least one mixing tool is not in the operational mixing tool use position. Analogous to the safety measure for the mixing tool drive unit, the safety function and/or safety device is extended here in that it ensures that the mixing container drive unit can also only be activated when the mixing tool is in the operational position. This prevents potential accidents and damage that can occur if the mixing container is to be rotated when the mixing tool is not properly positioned. Operators can therefore be sure that the mixing process only starts when all components are correctly aligned and secured, which minimizes the risk of accidents. This ensures compliance with the highest safety standards and regulations in terms of machine operation and occupational safety. Once again, the safety function and/or safety device can be implemented using the technical measures already described above to ensure that operation only takes place under safe conditions. As described above, these measures can be mechanical and/or electronic in nature and can include, for example, position sensors, safety switches and/or programmable logic controllers. These measures, individually or in combination, can thus be used to create physical and/or software-based interlocks in the broader sense, which ensure that the desired safety conditions are met before operation is enabled.

Furthermore, it may preferably be provided that the control unit is coupled with a time selection device, preferably with a time selection switch, by means of which the operating time of the mixing tool drive unit and/or the mixing container drive unit can be preset. Such a control unit enables precise electronic control of the drive units. This leads to a precisely controllable mixing process. Coupling with a time selection device also allows the operating time of the drive units to be programmed. This function thus enables time-efficient and automated operation, which is particularly useful if certain materials may only be mixed for a defined period of time.

According to a particularly preferred specific embodiment, it is also provided that the control unit is suitable and designed to activate and, if necessary, deactivate the mixing tool drive unit and the mixing container drive unit at the same time or with a time delay. A particularly preferred embodiment here is one in which the control unit is suitable and designed to activate the mixing tool drive unit at a time before the mixing container drive unit, so that the at least one mixing tool can be driven at a time before the mixing container. This ensures an advantageous, gentle start of the mixing process without major “turbulence” in the mixing material. Even if simultaneous operation of the mixing container drive unit and the mixing tool drive unit is preferred at least some of the time, it is of course also possible to provide or program operating modes in which only the mixing container drive unit or only the mixing tool drive unit is actuated by means of the control unit. This enables precise adaptation to special mixing requirements. For example, the mixing container can be rotated separately for certain mixing materials while the mixing tool is stationary, which can be advantageous for sand or gravel mixtures, for example. On the other hand, it is of course also possible to operate only the mixing tool, but not the mixing container, if this is required.

According to a further particularly preferred embodiment, it is provided that the mixing container drive unit is formed by a drive motor, preferably an electric motor, which drives a rotation axis which is connected, preferably centrally and centrally, to the underside of the rotatably mounted receiving element, preferably formed by a rotary platform or rotary platform. A drive motor, in particular an electric motor, can be controlled efficiently and precisely, with the central connection in particular ensuring efficient transmission of the drive power of the drive motor to the receiving element. The central and centered arrangement of the rotation axis also makes a significant contribution to ensuring that the mixing container rotates evenly and stably, which is important to ensure efficient and homogeneous material mixing. This also reduces vibrations during operation.

According to a further particularly preferred embodiment, it is provided that the mixing container holder has or forms a housing and/or frame part of the construction site mixing machine that is arranged on the floor side in relation to the vertical axis direction, whereby it is preferably provided that the housing and/or frame part has an elongated shape and/or is box-like and/or cuboid and/or movable. In addition to good accessibility, such a housing and/or frame part arranged on the floor also makes it possible to arrange or accommodate components of the construction site mixing machine there. This is particularly successful with an elongated shape or with a box-like and/or cuboid structure. The movability also ensures easy maneuverability of the construction site mixing machine on a construction site.

According to a further particularly preferred embodiment, it is provided that the mixing container holder, which has an elongated shape and/or is configured in the form of a box and/or cuboid, preferably has a length of between 0.4 m and 1.0 m and/or that the mixing container holder is configured on both sides opposite in the longitudinal direction with an engagement area for manual transport of the construction site mixing machine, preferably with the mixing container removed.

Further, according to a particularly preferred embodiment of the present inventive idea, it is also particularly advantageous if the drive motor is accommodated in the housing and/or frame part, wherein the rotation axis extends through the housing and/or frame part and is connected there directly or indirectly to a drive shaft of the drive motor. The integration of the drive motor in the housing and/or frame part helps to protect the motor from external influences such as dirt, water or other environmental factors that frequently occur on construction sites.

For a particularly compact design, it is also advantageous that the telescoping device, preferably a lower or the lower telescoping element of the telescoping device, is connected directly or indirectly to the mixing container receptacle having a housing and/or frame part, preferably to a projection of the mixing container receptacle having a housing and/or frame part which projects above the rotatably mounted receiving element, and projects upwards from this in the vertical axis direction. The telescoping device can project upwards in a straight line or, if necessary, also project upwards at an angle to the vertical in the vertical axis direction, preferably inclined by 1° to 10°, preferably by 3° to 6° to the vertical axis direction. With such an inclination, the position of the mixing tool, for example the position of an agitator basket of an agitator blade, can be advantageously adapted to a geometry of the receiving space of the mixing container, in particular to a receiving space that tapers conically downwards, for example in such a way that the mixing tool has the same distance from the container wall throughout. This allows equivalent mixing results to be achieved.

According to a further particularly preferred embodiment, a guided displacement device is provided which is suitable and designed to block a rotation of the upper telescopic element relative to the lower telescopic element when the upper telescopic element is lowered, preferably as a function of a defined lowering path of the upper telescopic element, and to release a positively guided linear transfer of the at least one mixing tool into the mixing tool use position. This enables secure positioning and/or alignment of the upper telescoping element and thus of the at least one mixing tool arranged on it in the mixing tool use position. In this context, it is advantageous for a structurally simple embodiment, which is also easy to manufacture, if the guided displacement device has at least one centering blade arranged on the upper telescoping element, preferably at least one centering blade projecting from a lower end region of the upper telescoping element facing the mixing container holder, which is suitable and designed to engage in a centering recess on the mixing container receptacle in a shape- and/or contour-adapted manner when the upper telescopic element is lowered, preferably as a function of a defined lowering path of the upper telescopic element, and to transfer the upper telescopic element into the mixing tool use position in a non-rotatable and positively guided manner.

A particularly advantageous design of the telescoping device results from a configuration in which the telescoping device has at least one, preferably elastic, pretensioning element by means of which the telescoping device can be pretensioned into the extended position and against the pretensioning force of which the telescoping device can be displaced into a collapsed position. Such a pretensioning element causes an efficient displacement of the telescoping device into the desired position, in this case into the extended position, in which the at least one mixing tool is in the non-use position. Such a preferably elastic pretensioning element thus helps to improve the functionality and user-friendliness and thus also the efficiency of the telescoping device of the construction site mixing machine. Particularly advantageously, the at least one elastic pretensioning element is formed by a gas pressure spring, which are low-maintenance elastic pretensioning elements that have a long service life and can also be pushed over without great force if the at least one mixing tool is to be transferred by the operator to the desired operational mixing tool use position.

According to a further particularly preferred embodiment, it is provided that the upper telescoping element can be rotated or pivoted relative to the lower telescoping element and in a horizontal plane about the longitudinal axis of the telescoping device in the extended position of the telescoping device. As a result, in the extended position of the telescoping device, the at least one mixing tool can be pivoted by means of the upper telescoping element in a horizontal plane lying above the upper edge of the mixing container in a functionally reliable and convenient manner into a mixing tool insertion position, in which the at least one mixing tool is located directly above the outlet opening of the mixing container and is prepared for transfer into the operational mixing tool use position. In addition to a compact design, this has the advantage that the entire mixing tool can be completely swiveled away from the area above the mixing container, which simplifies the filling of the mixing container as well as its removal or loading. Accordingly, according to a particularly preferred embodiment, it is also provided that the at least one mixing tool, in the extended position of the telescoping device, can be pivoted away from the mixing tool insertion position into a filling position by means of the upper telescoping element in the horizontal plane lying above the upper edge of the mixing container in such a way that the at least one mixing tool is arranged laterally outside the mixing container and/or exposes the outlet opening of the mixing container for filling.

According to a particularly preferred specific embodiment for this purpose, a swivel angle limiting device, preferably at least one stop element as a swivel angle limiting device, is also provided, by means of which the swivel angle of the upper telescoping element relative to the lower telescoping element and thus the two maximum pivot positions are limited. This contributes significantly to increasing the overall functional reliability, whereby it is preferably provided that a first maximum pivot position essentially corresponds to the mixer insertion position, and in which the at least one mixing tool is located directly above the outlet opening of the mixing container, while a second maximum pivot position is a pivot position in which the at least one mixing tool is arranged laterally outside the mixing container and/or is pivoted outwards by at least 60°, preferably by approximately 95° or even further, i.e. by at least 60°, away from the mixing tool insertion position.

According to another particularly preferred embodiment, a locking mechanism is provided which is suitable and configured to releasably lock the upper telescopic element swiveled back from the mixing tool insertion position in the direction of the filling position as a function of a predetermined swivel path. This reliably prevents unwanted swiveling back of the upper telescoping element and thus ensures reliable filling of the mixing container. In addition, the locking mechanism ensures that a suction device arranged on the upper telescopic element, which is described in more detail below, is held in the desired suction position in a functionally safe manner. The detachable locking mechanism is achieved in a functionally and technically simple manner, in particular with an embodiment in which the locking mechanism is configured as a detachable latching and/or snap connection, and in which a latch element pretensioned in the direction of latching engagement by means of a pretensioning element snaps behind a latch counter element after a predetermined swivel path and latches there. In this context, it may also be provided that the latch element is coupled with an actuating element, preferably with a manually operable button, by means of which the latch element can be brought out of latching engagement with the latching counter element for unlocking against the force of the pretensioning element. Alternatively or additionally, it can also be provided that the latch element can be brought out of engagement with the latch counter element by displacing the upper telescopic element upwards or downwards in the telescopic axis direction, so that pivoting of the upper telescopic element, preferably in the direction of the mixing tool insertion position, is enabled in this height position of the upper telescopic element. This increases the variability and flexibility of the design.

According to another particularly preferred design, a suction device is provided on the upper telescoping element, preferably in a lower area of the upper telescoping element in relation to the vertical axis direction, by means of which suction material that collects in the area of the outlet opening of the mixing container can be extracted. A suction device of this type can be used to avoid or minimize contamination. For a simple embodiment, it is preferable for the suction device to be open on both sides and/or to have a suction pipe formed by a straight piece of pipe, the first suction pipe opening of which is located in the extended position of the telescoping device in the area above the upper edge of the mixing container, preferably directly above the upper edge of the mixing container and/or which, in a suction position, is aligned in the direction of the outlet opening of the mixing container, and the second suction pipe opening of which is or can be coupled, preferably detachably, to a suction device.

For example, in conjunction with a pivot angle limiting device described above and/or a locking mechanism, but not only therewith, it can be provided in accordance with a further particularly advantageous embodiment, which supports functionally safe operation of the construction site mixing machine, that the first suction pipe opening of the suction pipe in the filling position, in particular in the second maximum pivot position, is aligned in the direction of the outlet opening of the mixing container and/or that the first suction pipe opening is beveled, preferably with a bevel angle of 15° to 45°. On the one hand, this increases the suction surface and, on the other hand, the mixing container cannot get caught on the suction pipe when it is removed.

For efficient and functionally reliable operation of the telescoping device, it is advantageous according to a further particularly preferred embodiment that the telescoping device has a guided displacement device which releases the lowering of the upper telescoping element only in the mixing tool insertion position, in which the at least one mixing tool is located directly above the outlet opening of the mixing container. Such a guided displacement device thus helps to avoid operating errors in a functionally safe and reliable manner. The guided displacement device can, for example, have a first forced guidance element arranged or formed on the lower telescoping element, for example a guide slot, which interacts with a second forced guidance element arranged and formed on the upper telescoping element, for example a sliding block, which is forcibly guided in the guide slot. Of course, a kinematic reversal is also possible here, in which the first constraining guide element is formed by the sliding block, while the second constraining guide element then forms the guide link in the opposite direction.

In order to enable functionally safe operation of the telescoping device, especially in rough construction site operation, in which the telescoping device is safely and reliably protected from soiling, it is advantageous according to a particularly preferred design if the lower telescoping element is accommodated in the upper telescoping element when it is pushed together.

According to a further particularly preferred embodiment, a (possibly further) locking mechanism, in particular a spring-loaded locking mechanism, is provided, by means of which the telescoping device is releasably locked in the, preferably operational, mixing tool use position of the at least one mixing tool, preferably in such a way that the locking mechanism is only releasably locked when the at least one mixing tool is in the, preferably operational, mixing tool use position. In a preferred embodiment, such a locking mechanism thus represents an essential component of the safety function or safety device, since it ensures, on the one hand, that the at least one mixing tool is held securely in the operational mixing tool use position. On the other hand, it also ensures that the desired operational mixing tool use position is only reached when the locking mechanism has releasably locked the mixing tool displacement device. Thus, in particular in conjunction with the specific design of the safety function or safety device explained in more detail below, the operational mixing tool use position of the at least one mixing tool can be easily monitored.

The locking mechanism can in principle be designed in different ways, but preferably has a latch element formed on the upper telescoping element, which in the locking position interacts with a latch counter-element in the area of the lower telescoping element and/or in the area of the mixing container holder. For example, the locking mechanism is formed by a stable and easy-to-produce spring-loaded locking mechanism, which has a latch element formed on an upper telescopic element, which interacts with a spring-loaded latch counter element in the area of the lower telescopic element and/or in the area of the mixing container receptacle, which can be pressed over to establish the latching connection. Of course, a corresponding kinematic reversal is also possible here, in which the spring-loaded locking mechanism has a latch element formed in the region of the lower telescopic element and/or in the region of the mixing container receptacle, which interacts with a spring-loaded latch counter-element on the upper telescopic element that can be pressed over to establish the latching connection.

Furthermore, it is advantageous if the locking mechanism cooperates with an unlocking mechanism by means of which the locking of the telescoping device can be released, in particular actively released. This is achieved, for example, by the unlocking device being formed by an unlocking element mounted on the telescoping device, preferably by a lever, upon actuation of which the latching counter element can be disengaged from the latch element, preferably against the action of a spring force.

According to a further particularly preferred embodiment, it can also be provided that the telescoping device, preferably an upper or the upper telescoping element of the telescoping device, can be displaced in the unlocked state, preferably essentially automatically, by means of the elastic pretensioning element, preferably a gas pressure spring, in the direction of the extended position. This is a simple way of ensuring that the telescoping device moves back into the desired position, namely into the extended position, in which the at least one mixing tool can be easily and reliably moved away from the mixing container by means of the upper telescoping element, which can be pivoted horizontally about the lower telescoping element.

According to a particularly advantageous embodiment, which contributes significantly to increasing the overall operational safety of the construction site mixing machine, it is provided that the above-described safety function and/or safety device is formed by a monitoring device, preferably a monitoring device forming part of the mixing tool displacement device, or that the above-described safety function and/or safety device has a monitoring device, preferably a monitoring device forming part of the mixing tool displacement device. This monitoring device is coupled to the control unit in a signal-transmitting manner and is also suitable and designed to detect at least the operational mixing tool use position of the at least one mixing tool, for example by sensors and/or by means of at least one switch, and to enable operation of the mixing tool drive unit and/or the mixing container drive unit-when the actuation device is activated-only when the at least one mixing tool is in the operational mixing tool use position. A “monitoring device” in the sense of the present invention is understood to mean all conceivable sensors or switches which, in conjunction with a safety function and/or a safety device, are suitable for monitoring the position or state of a moving component in a system and triggering corresponding signals or actions when a certain position is reached. The term “monitoring device” in the sense of the present invention idea thus includes, on the one hand, all types of switches, including limit switches, which are placed at the end of a movement path. On the other hand, it also includes all types of sensors, such as light barriers, magnetic field sensors or optical sensors, which are used to detect the position of objects or components.

According to a particularly preferred specific embodiment of the present inventive idea, the monitoring device is a component of the telescoping device. With such a telescoping device, the respective position of the at least one mixing tool can be monitored particularly easily as a function of the position of the telescoping elements, which can be displaced relative to one another.

Furthermore, a specific embodiment is advantageous in which the monitoring device has a safety sensor and/or a safety switch, preferably a position switch, which is coupled to the control unit in a signal-transmitting manner. According to a specific embodiment for this, it may be provided that the safety switch is deactivated in the operational mixing tool use position of the at least one mixing tool and thus when the telescoping device is pushed together, so that operation of the mixing tool drive unit and/or the mixing container drive unit is enabled. The control unit can then control or activate the mixing tool drive unit and/or the mixing container drive unit in the desired, preferably programmed, manner when the actuation device is activated at the same time. Furthermore, the safety switch is activated in the non-operational mixing tool use position of the at least one mixing tool and thus when the telescoping device is at least partially extended, so that operation of the mixing tool drive unit and/or the mixing container drive unit is blocked. In this state—even when the actuation device is activated—the control unit preferably blocks the operation of the mixing tool drive unit and, if present, possibly also of the mixing container drive unit.

According to a further particularly preferred embodiment, a bridging device is provided which is coupled to the control unit in a signal-transmitting manner and which is suitable and designed to activate the mixing tool drive unit when it is actuated and/or when the actuation device is activated, if the at least one mixing tool is not in the operational mixing tool use position, or to block it if the at least one mixing tool is in the operational mixing tool use position, so that the mixing tool drive unit cannot be activated in the operational mixing tool use position by means of the bridging device. Preferably, the bridging device has a freely accessible manual switch, preferably on the mixing tool drive device, most preferably on a handle device of the mixing tool drive device, upon actuation of which the bridging device can be activated, preferably only when the actuation device is activated, and preferably can be activated in a speed-controlled manner. The speed-controlled activation can be implemented particularly easily and reliably with a manual switch, for example in such a way that the more the manual switch is pressed in, the faster the mixing tool drive unit runs. This means, for example, that the more the bridging device formed by a manual switch is pressed or depressed, the faster the drive motor runs. This function enables the user to dip the at least one mixing tool into the mixing material in a targeted and slow manner with manual speed control through the bridging device when the mixing container is not yet rotating, so that spraying out of the material is avoided. This is particularly advantageous if, as will be explained in more detail below, according to a particularly preferred embodiment, the mixing container does not rotate for safety reasons until the outlet opening of the mixing container is covered by a cover element. After the mixing process, the mixing tool drive device and the mixing container drive device preferably switch off simultaneously, so that the mixing container is no longer driven when the at least one mixing tool is pulled out of the mixing material, but preferably remains firmly in its position. And even now, the at least one mixing tool can be pulled out of the mixing container again in a targeted and slow manner. In addition, this also allows the mixing material to be ejected successively in a targeted manner at a controllable speed, depending on the operator's wishes, and the materials adhering to the mixing tool can be ejected without spraying out. The mixing tool is then almost free of adhered mixing material and can be used again immediately without further cleaning.

According to a further particularly preferred embodiment, it is provided that the telescoping device, preferably in the area above the at least one mixing tool, has a cover element which can be displaced together with the at least one mixing tool and, in the preferably operational position, closes the mouth opening of the mixing container at least in part, preferably in such a way that no finger access into the receiving space of the container is possible and/or closes the mouth opening of the mixing container at least in part, the outlet opening of the mixing container, preferably in the area above the at least one mixing tool, preferably in such a way that no finger access into the receiving space of the container is possible and/or a gap distance between the peripheral edge area of the cover element and a container wall adjoining or adjacent to the cover element on the periphery is maintained. Such a cover element reliably closes the outlet opening of the mixing container in the operational mixing tool use position, which prevents the risk of accidents due to accidental intervention in the mixing container while the mixing process is running. In addition, the cover element also protects against the ingress of unwanted foreign bodies, such as dust or other impurities, which could impair the mixing process. This also reliably prevents mixing material from spraying out. A gap between the peripheral edge area and the container wall area adjacent to the cover element also ensures collision-free, unhindered rotation of the mixing container relative to the cover element.

For a compact and easy-to-manufacture design, it is particularly preferable that the cover element, preferably formed by a cover plate or a lid, is arranged on the upper telescoping element and can be lowered together with it.

For a further particularly compact design, which effects a simple functional separation of the at least one mixing tool from the mixing tool drive unit, it is provided that the cover element is arranged between the at least one mixing tool and the mixing tool drive unit.

The mixing tool drive unit is preferably formed by a drive motor, preferably an electric motor, whose at least one drive shaft drives the at least one mixing tool in rotation. Such drive motors can reliably deliver a desired high power and torque, which is particularly important when heavy and viscous materials need to be mixed. This promotes an efficient mixing process. Drive motors, especially in the form of electric motors, also offer the possibility of variable speed control, which provides increased flexibility in terms of different mixing requirements and different materials. In addition, electric motors can be operated with high energy efficiency and are characterized by a long service life with low maintenance. In conjunction with a drive motor of this type, it is also possible to guide the at least one drive shaft or a connecting part of the at least one mixing tool that can be connected to the at least one drive shaft through the cover element in a simple manner for a particularly compact design. This reliably maintains the original functionality of the cover element.

According to a further particularly preferred embodiment, the covering element can have at least one, preferably elongated and/or pin-like and/or strip-like, edge wiper which, in the operational mixing tool use position, projects into the receiving space of the mixing container, preferably spaced there with a defined gap distance from the inner wall of the receiving space. The arrangement of the edge wiper on the cover element results in a compact and space-saving arrangement, which also helps to reduce component costs, as the cover element no longer assumes its original covering function of the outlet opening of the mixing container in an advantageous dual function, but also a holding function for the edge wiper. The edge scraper also essentially helps to minimize the formation of material deposits on the inner walls of the receiving space. This is not only beneficial for the overall cleanliness of the mixing process, but also for an even distribution of material during the mixing process. This has the advantage of optimizing the mixing quality.

According to a further particularly preferred embodiment, it is provided that the mixing tool drive unit, preferably a drive motor, is accommodated in a drive unit housing which is arranged on the upper telescopic element, preferably in the area above the mixing container receptacle. On the one hand, accommodating the mixing tool drive unit, in particular a drive motor, in a drive unit housing ensures that the mixing tool drive unit is reliably protected from environmental influences, such as dust, moisture or other potential soiling, such as may occur on a construction site. It also helps to extend the service life of the drive unit and reduce maintenance costs. It also contributes to occupational safety, especially when operators are in the vicinity of the mixing machine. In addition, an aesthetically pleasing design can be achieved by integrating the mixing tool drive unit into a drive unit housing on the upper telescopic element. The arrangement of the drive unit housing on the upper telescopic element also makes it easy to connect additional components, such as control elements or sensors, in a simple and functionally reliable manner.

The latter also applies to a particularly preferred embodiment in which the drive device housing has a handle device. The handle device enables particularly convenient operation of the telescoping device, in particular also intuitive operation by the operator, in order to move the at least one mixing tool into the desired positions by means of the telescoping device. Particularly advantageous in this context is an embodiment in which it is provided that the handle device has two, preferably approximately U-shaped, handle elements, preferably each with at least one handle spaced from the drive device housing, located on opposite sides of the drive device housing as viewed transversely to the vertical axis direction. Such a handle device enables particularly advantageous two-handed operation of the telescoping device when transferring the at least one mixing tool into the desired mixing tool position.

For the energy supply, the construction site mixing machine preferably has an energy connection, preferably a cable connection, via which the construction site mixing machine can be supplied with energy, whereby electrical lines are routed from the energy connection to the components and functional units that can be supplied with energy, in particular with electricity. Specifically, it can be provided for this purpose that at least one contact element arranged on the lower telescoping element or on the mixing container holder interacts with a counter-contact element arranged on the upper telescoping element, which is connected to the control unit in a signal-transmitting manner, in such a way that the contact element is in contact with the counter-contact element in the operational mixing tool use position of the at least one mixing tool and thus when the telescoping device is pushed together, so that the mixing tool drive unit can be controlled and activated by the control unit when the actuation device is activated. Such a configuration represents an additional safety function, as the mixing container drive unit can only be activated and actuated when the mixing tool has been moved to the correct operational mixing tool use position. Similarly, as an alternative or additionally for the energy supply of the mixing container drive unit, it can be provided that, preferably additionally, at least one, preferably further, contact element is arranged on the lower telescoping element or on the mixing container holder, which is connected to a, preferably further, mating contact element arranged on the upper telescoping element, which is connected to the energy connection in an energy-transmitting manner, in such a way that the contact element is in contact with the counter-contact element in the operational mixing tool use position of the at least one mixing tool and thus when the telescoping device is pushed together, so that the mixing tool drive unit can be supplied with energy when the actuation device is activated. This type of contact or contact transmission also has the advantage that no trailing cable needs to be carried along during the vertical movement in the x-direction.

According to a further particularly preferred embodiment, it is provided that on the upper telescoping element, preferably on the upper free end region of the upper telescoping element, a handle element, preferably a bow handle as handle element, is provided, which projects from the upper telescoping element, and/or that at least one wheel, preferably at least one wheel axle with two wheels opposite one another in the transverse direction, and/or at least one carrying handle is arranged on the mixing container receptacle, preferably in the region below the handle element, wherein it is preferably provided that the wheel axle forms the carrying handle. Such a handle element offers a safe way to transport the construction site mixing machine, in particular to move it, if the construction site mixing machine is designed to be movable, for example by means of wheels arranged on the mixing container holder. This is particularly advantageous with a structure in which the handle element is arranged on the side of the upper telescopic element opposite the mixing container and/or the drive unit housing and/or with a structure in which the at least one wheel is arranged below the handle element in relation to the vertical axis direction. If a carrying handle is provided, the mixing machine can also be conveniently gripped and transported. And if the carrying handle is also formed by the wheel axle, this results in a high level of functional integration with reduced components.

Furthermore, the control unit, which is preferably an electronic control unit, can also be arranged on the side of the upper telescoping element opposite the mixing container and/or the drive unit housing, whereby the handle element is then arranged above the control unit in relation to the vertical axis direction and/or projects above the control unit with a handle element section. As a result, the handle element can also form a fall protection element in a particularly advantageous dual function, which prevents the control unit from being damaged if the construction site mixing machine falls over.

The handle element and wheel or wheels also enable a design in which the at least one wheel projects laterally over the mixing container holder with at least a partial area in such a way that the construction site mixing machine in a lying position rests and is supported on a support surface, for example a floor as a support surface, on the one hand by means of the at least one wheel and on the other hand by means of the handle element, and the mixing container and the mixing tool drive unit together with the at least one mixing tool lie on top. In such a horizontal position, for example, the construction site mixing machine can be easily transported or stowed in a compact manner. In addition, particularly in conjunction with a control unit, as already described above, this also provides functionally reliable fall protection that reliably prevents damage to the control unit.

For a functionally reliable support structure of the construction site mixing machine in its position of use, it is also advantageous if at least one support foot is arranged on the side opposite the at least one wheel of the mixing container holder, which has an elongated shape and/or is designed like a box or cuboid.

The mixing container and in particular the receiving space of the mixing container can in principle have any suitable shape. However, a particularly advantageous embodiment is one in which at least the receiving space of the mixing container, preferably the mixing container as a whole, has an essentially circular cylindrical and/or downwardly tapering conical shape. Such mixing containers are easy to manufacture and are particularly suitable for optimized and efficient use of a mixing process of a construction site mixing machine according to the invention. The mixing containers preferably and merely by way of example have a filling volume of 20 liters to 50 liters. In particular, a rotating drive of such a mixing container is advantageous, as it reliably helps to avoid unwanted imbalances.

The at least one mixing tool can, in principle, be firmly and non-detachably connected to the mixing tool drive unit. This can be the case, for example, with construction site mixing machines that always have to perform the same mixing tasks. However, for increased flexibility and functionality, it is advantageous if the at least one mixing tool can be detachably connected to the mixing tool drive unit. This allows different mixing tools, for example stirrers with different geometries, to be used and interchanged with one another, making it easy to adapt the mixing tools to different mixing materials. Alternatively or additionally, the flexibility and variety of use can also be increased by the fact that the at least one mixing tool is mounted on the mixing tool drive unit in a height-adjustable manner.

The control unit itself can usually have a microcontroller or a PLC (Programmable Logic Controller), which processes the incoming signals, executes the control logic and sends control signals to, for example, the drive motor of the at least one mixing tool. The, preferably programmable, control unit can also usually have a control panel with switches, buttons and possibly a display, which enables the operator to control the construction site mixing machine and monitor the operating status. This can include setting the mixing speed, start/stop functions and, of course, other desired parameters.

The invention further relates to a method of operating a construction site mixing machine according to the independent method claim. The advantages resulting therefrom are identical to the advantages of the construction site mixing machine described above according to any one of the dependent claims, so that reference is made to the foregoing in order to avoid repetition.

This problem is further solved with the features of the independent construction site mixing machine claim. Advantageous embodiments are the subject of the subclaims referring back to it.

According to the construction site mixing machine, in particular a mobile construction site rotary mixing machine, is provided for mixing materials, in particular for mixing plasters, screeds, concrete, mortar, slurries or resins, which has an upwardly open mixing container which is suitable and designed to receive a mixing material in its receiving space. Furthermore, the construction site mixing machine comprises at least one mixing tool which can be driven in rotation by means of a mixing tool drive unit, wherein the at least one mixing tool is suitable and designed to be received in a mixing tool use position in the receiving space, preferably by displacement by means of a mixing tool displacement device. Furthermore, a rotatably mounted mixing container receptacle is provided, which receives the mixing container and can be rotationally driven by a mixing container drive unit, so that the mixing container can be rotated during a mixing process. A control unit electronically controls the activation and deactivation of the mixing tool drive unit and the mixing container drive unit.

According to a first aspect of the invention of the construction site mixing machine claim, the control unit is configured to drive the mixing container by means of the mixing container drive unit in the opposite direction, preferably exclusively in the opposite direction, to the at least one mixing tool that can be rotationally driven by the mixing tool drive unit. For example, the at least one mixing tool can be driven clockwise and the mixing container can be driven in the opposite direction of rotation, i.e. counterclockwise. Alternatively, the at least one mixing tool can be driven counterclockwise and the mixing container clockwise. This also expressly includes movement patterns in which the counter-rotating movement is supplemented by oscillating movements or movements with varying speed, whereby the basic requirement of the counter-rotating direction of rotation is maintained. The counter-rotating direction has the advantage that the speed of the mixing container remains constant in relation to the mixing tool, ensuring a stable and efficient mixing process. In such cases, i.e. when the drive units are running in the same direction, the mixing container can already be driven forward by the mixing tool drive unit, causing the mixing container drive unit to fluctuate between “braking” and “driving”.

Even if the purely counter-rotating direction of rotation is preferred, the control unit can in principle also be configured in such a way that it also enables a co-rotating direction of rotation between the mixing container drive unit and the mixing tool drive unit. This can be done intermittently or intermittently, for example in such a way that the drive is counter-rotating for a first period of time and then co-rotating for a second period of time. This pattern can then be repeated identically for a predetermined mixing time, whereby variations are possible within the pattern with regard to the duration of the time periods and/or the drive speeds. This offers the advantage of being able to flexibly adapt the construction site mixing machine to different mixing requirements and mixing materials, i.e. with either counter-rotating or co-rotating directions of rotation of the two drives. The possibility of providing different directions of rotation makes the construction site mixing machine according to the invention universally applicable and increases its versatility in different application scenarios.

According to a second aspect of the invention of the construction site mixing machine claim, which is alternative to the first aspect of the invention or also additional, the control unit can have a timer function by means of which the operating time of the mixing tool drive unit and/or the mixing container drive unit can be set and/or can be controlled. Such a control unit enables precise electronic control of the drive units and helps to adapt the mixing process to specific requirements. This results in a precisely controllable mixing process, which can improve both the quality of the end product and the efficiency of the mixing process. In addition, the timer function reduces manual intervention by the operator and thus minimizes the risk of operating errors.

Irrespective of the fact that the two aspects of the invention can be used independently of each other, their combination also offers a synergy that optimizes the mixing process in terms of both efficiency and precision: In particular, the synergy arises from the fact that the counter-rotating motion of the drive units makes the mixing process efficient, while the timer function precisely times the mixing process. This combination minimizes operating errors, reduces manual intervention and increases overall productivity. This synergy is particularly advantageous for mixing materials that require a defined processing time, such as reactive resins or special mortars.

The electronic control unit itself can usually have a microcontroller or a PLC (Programmable Logic Controller), which processes the incoming signals, executes the control logic and sends control signals to, for example, the mixing tool drive unit and the mixing container drive unit. The, preferably programmable, control unit can also basically have a control panel with switches, buttons and/or a display, which enables the operator to monitor the operating status and possibly also control the construction site mixing machine, should this be desired. This can include, for example, setting the mixing speed, start/stop functions and, of course, other desired parameters.

According to a particularly preferred specific embodiment, the control unit is configured to drive the mixing container by means of the mixing container drive unit at least intermittently, preferably at a speed of approximately 5 to 40 min⁻¹, most preferably of approximately 8 to 35 min⁻¹, in a first direction of rotation and/or to drive the at least one mixing tool by means of the mixing tool drive unit at least intermittently, preferably at a speed of 250 to 900 min⁻¹, most preferably from 300 to 800 min⁻¹, in a second direction of rotation opposite to the first direction of rotation. A speed of the mixing container in the range of approximately 5 to 40 min⁻¹, preferably from approximately 8 to 35 min⁻¹, enables adaptation to different mixing materials and uniform rotation of the mixing container, which reliably prevents the mixing material from spilling over-even at high speeds of the mixing tool. This achieves a homogeneous mixing pattern and increases the efficiency of the mixing process. A preferred speed of the at least one mixing tool of approximately 250 to 900 min⁻¹, preferably of approximately 300 to 800 min⁻¹, generates sufficiently high shear forces to mix or homogenize both liquid and viscous mixing materials effectively and without lump formation. This range enables the processing of various materials, from easy-flowing to highly viscous substances such as concrete or resins. A particular advantage also lies in the combination of the two speed ranges mentioned: the relatively low speed of the mixing container ensures that the mixing material is evenly distributed in the container, while the higher speed of the mixing tool ensures intensive mixing. The combination of these speeds ensures an optimal balance between the movement of the entire mixing material and local mixing, which ensures a homogeneous result. In addition, the opposite direction of rotation creates an additional relative speed between the mixing material and the mixing tool, which increases the mixing effect without having to increase the speeds further.

The control unit also preferably contains a performance monitoring device which is suitable and designed to monitor the performance of the mixing container drive unit. This includes, for example, the measurement of power consumption, torque or similar parameters in order to ensure optimum control and protection of the mixing container drive unit.

According to a further particularly preferred embodiment, an actuation device is provided by means of which the control unit can be activated and, if necessary, deactivated. Such an actuation device enables simple and preferably also intuitive operation of the construction site mixing machine, for example by allowing the control unit to be quickly activated or deactivated by a manual and/or throttle switch as an actuation device or as part of the actuation device. The actuation device can be designed differently depending on the embodiment variant and can, for example, be designed as a system with several operating elements, such as switches or buttons, which are coupled to the control unit and/or to each other and interact. Alternatively, the actuation device can also be formed by a single operating element, such as a throttle switch, which enables the control unit to be activated and/or deactivated.

In a particularly preferred embodiment, the actuation device can thus comprise a throttle switch or be formed by a throttle switch which, for example and preferably, is configured as an ergonomic hand switch.

Accordingly, according to a preferred embodiment, it is therefore provided that the actuation device contains a throttle switch as a manual switch or is formed by a throttle switch configured as a manual switch. It is typically located in the area of a handle of the mixing machine and can be actuated manually by pushing or pulling, preferably by pressure. Alternatively, the throttle switch can in principle also be arranged elsewhere on the construction site mixing machine as a separate operating element. According to a particularly preferred specific embodiment, the throttle switch is suitable and configured to activate the mixing tool drive unit and/or regulate its speed. In a particularly preferred embodiment for this purpose, the throttle switch enables infinitely variable regulation of the mixing speed, for example by increasing pressure on the throttle switch. In addition, the throttle switch can also have a mechanical locking function to activate continuous operation.

In a further particularly preferred embodiment, the actuation device additionally contains a mechanical actuation lever which interacts with the throttle switch. The actuation lever is suitable and configured to mechanically actuate the throttle switch as a function of the position of the mixing tool, preferably in such a way that a continuous operation mode of the mixing tool drive unit is set and/or activated when the operational mixing tool use position is reached. Accordingly, according to a particularly preferred embodiment, the actuation lever is suitable and designed to mechanically actuate the throttle switch (only) when the operational mixing tool use position is reached. This mechanical actuation then enables reliable and permanent activation of the mixing tool drive unit and thus a continuous operation mode, for example with the throttle switch pressed to the maximum and thus at maximum speed of the mixing tool. The mechanical actuation lever contributes to the safety of the construction site mixing machine by ensuring that the continuous operation mode is only activated when the mixing tool is in the correct position.

According to a preferred specific embodiment, the actuation lever can be arranged, for example, at of a mixing tool displacement device described in more detail below, in particular at the upper telescopic element, the actuation lever being assigned a stop element at the mixing tool displacement device, in particular at a lower telescopic element, against which the actuation lever comes to a stop after a defined displacement path when the mixing tool is displaced into the mixing tool use position, against which the actuation lever comes into abutment after a defined displacement path when the mixing tool is displaced into the mixing tool use position, so that the actuation lever is actuated, in particular pivoted, and actuates the throttle switch when the mixing tool is further displaced into the mixing tool use position. In an exemplary and particularly preferred embodiment, the actuation lever acts on the one hand, preferably directly, on the throttle switch, while on the other hand a, preferably mechanical, stop element is provided, preferably in the area of the mixing tool displacement device described in more detail below, in particular on the lower telescopic element, which causes that, when the mixing tool is displaced into the mixing tool use position after a defined displacement path, the actuation lever initially comes to rest against the stop element and, as a result, when the mixing tool is displaced further in the direction of the mixing tool use position, the actuation lever is actuated, preferably pivoted, in such a way that it acts on the throttle switch and actuates it. The mechanical actuation of the throttle switch ensures that the continuous operation mode is only activated in the correct position. The actuation lever and/or the throttle switch can also optionally be equipped with a return spring, which ensures that the actuation lever or the switch is automatically returned to the rest and starting position when the mixing tool is moved out of the operational mixing tool use position again.

According to a further particularly preferred embodiment, the control unit, the mixing tool and the mixing tool drive unit are part of a hand mixer. Such a hand mixer, which is basically known in the art, is a portable, motorized device specifically configured and manufactured for mixing and processing mixing materials such as mortar, concrete, screed or similar materials. Unlike food processors, which are configured for processing food, a hand mixer is designed for use in demanding environments such as construction sites or workshops. It is characterized by a robust design that meets the requirements of construction and craft materials, and has a mixing tool drive unit designed for high torque to efficiently process viscous or heavy mixing materials. The mixing tool, usually in the form of a stirring rod or whisk, is optimized for direct use in larger containers and can usually be interchanged to meet different mixing requirements. In addition, a hand mixer is manually operated and usually offers ergonomic handles and intuitive controls to ensure comfortable and safe handling.

Accordingly, in a particularly preferred embodiment, the hand agitator of the present construction site mixing machine also comprises a handle unit and a drive unit housing in which the mixing tool drive unit, preferably a drive motor, is accommodated. Such an embodiment permits further optional configurations.

For example, an actuating element, e.g. a hand switch, preferably arranged on the handle device allows the operator an intuitive actuation or operation of the mixing tool drive unit that is familiar and thus familiar from conventional hand mixers. The hand grip device also enables the operator to easily move the at least one mixing tool into the desired positions by means of a displacement device, which is preferably present or provided on the construction site mixing machine and can be formed, for example, by a telescoping device. In this context, another particularly advantageous embodiment is one in which, alternatively or additionally, the handle device is provided with two preferably approximately U-shaped handle elements located on opposite sides of the drive device housing, as viewed transversely to the vertical axis direction, preferably each with at least one handle spaced apart from the drive device housing. Such a specific design thus not only enables an arrangement of the actuating element, for example in the form of a hand switch, on the handle device that is familiar to the operator from conventional hand mixers, but also enables particularly advantageous two-handed operation when transferring the at least one mixing tool into the desired mixing tool position.

In addition, the manual agitator can in principle be firmly and non-detachably arranged or mounted on the construction site mixing machine, preferably on a mixing tool displacement device described in more detail below. In this embodiment, the manual agitator then forms an integral part of the construction site mixing machine or a mixing tool displacement device. According to a particularly preferred embodiment, however, the manual agitator is preferably formed by a separate component which is detachably arranged or mounted on the construction site mixing machine, preferably on a mixing tool displacement device described in more detail below. As a result, the manual agitator can advantageously also be used separately and independently of the construction site mixing machine, which significantly increases the flexibility with regard to the use of such devices.

In principle, the control unit and, if present or provided, an actuation device can of course also be arranged at any other suitable position on the construction site mixing machine, which will also be explained in more detail below.

According to a further particularly preferred embodiment, it is provided that the control unit contains a timer device with a timer function which is suitable and configured to count down an adjustable and/or predeterminable period of time and to automatically deactivate the mixing tool drive unit and/or the mixing container drive unit after this period of time has elapsed. By automatically deactivating the mixing tool and/or mixing container drive unit after an adjustable and/or predeterminable period of time has elapsed, the mixing process is precisely controlled, which is particularly important for mixing materials with specific processing times. This prevents both over-mixing and under-mixing, which improves the quality of the mixing material. In addition, the timer function reduces manual intervention by the operator and thus minimizes the risk of operating errors. This not only leads to greater efficiency in the workflow, but also increases safety, as the mixing process is automatically stopped once the specified time has elapsed. The timer function also allows flexible adaptation to different mixing requirements and material properties. This functionality is particularly advantageous for mixing materials that have to be processed in defined time windows, such as reactive resins or special mortars.

Furthermore, it may preferably be provided that the control unit, preferably the timer unit, is coupled with a time selection device, preferably with a time selection switch, by means of which the operating time of the mixing tool drive unit and/or the mixing container drive unit can be preset. The operating time of the mixing tool drive unit and/or the mixing container drive unit can be set in various stages or continuously. Such a design enables a time-efficient and automated mode of operation and is particularly advantageous if the mixing material may only be mixed over a defined period of time in order to achieve optimum results.

According to a particularly preferred specific embodiment, it is also provided that the control unit is configured to activate and, if necessary, deactivate the mixing tool drive unit and the mixing container drive unit at the same time or with a time delay. A particularly preferred embodiment here is one in which the control unit is configured to activate the mixing tool drive unit at a time before the mixing container drive unit, so that the at least one mixing tool can be driven at a time before the mixing container. This ensures an advantageous smooth start of the mixing process without major “turbulence” in the mixing material. Even if simultaneous operation of the mixing container drive unit and the mixing tool drive unit is preferred at least some of the time, it is of course also possible to provide or program operating modes in which only the mixing container drive unit or only the mixing tool drive unit is actuated by means of the control unit. This enables precise adaptation to special mixing requirements. For example, the mixing container can be rotated separately for certain mixing materials while the mixing tool is stationary, which can be advantageous for sand or gravel mixtures, for example. On the other hand, it is of course also possible to operate only the mixing tool, but not the mixing container, if this is required.

According to a further particularly preferred embodiment, it is provided that the control unit has a safety function and/or safety device which is suitable and configured to enable operation of the mixing container drive unit and/or the mixing tool drive unit, preferably with the actuation device activated, when the at least one mixing tool is in the operational mixing tool use position, and/or to block or switch off when the at least one mixing tool is or is no longer in the operational mixing tool use position. The latter can also be provided in particular in the event that an actuating element or an actuation device is actuated, for example by means of a manual and/or throttle switch. This can mean, for example, specifically that the mixing container drive unit and/or the mixing tool drive unit is only switched on or activated when the at least one mixing tool is in the desired operational mixing tool operating position, in which the mixing tool is held in the mixing container in the desired manner, and/or that the mixing container drive unit and/or the mixing tool drive unit is automatically stopped when the at least one mixing tool is moved out of this operational mixing tool operating position. A safety function and/or safety device equipped in this way ensures safe operation of the mixing tool drive unit and the mixing container drive unit and offers a variety of advantages:

It recognizes the correct position of the mixing tool and can, for example, ensure that the mixing tool drive unit can only be operated in the operational mixing tool use position. Similarly, it can optionally ensure that the mixing container drive unit is also only activated when the mixing tool is correctly positioned. This prevents accidents and damage that could occur if the mixing container is to be rotated when the mixing tool is not positioned correctly and ensures that the mixing process as a whole only starts when all components are correctly aligned and secured.

The safety function and/or safety device can be implemented using a wide variety of technical measures, which can be both mechanical and electronic in nature. For example, the control unit can be equipped with position sensors as a safety device that detect whether the mixing tool is in the operational position. Alternatively or additionally, a safety switch can be provided, which is activated when the mixing tool is brought into the operational position. This safety switch can be connected to the control unit and enable operation of the mixing tool and/or mixing container drive unit when the correct positions have been reached.

Finally, the safety function can alternatively or additionally be implemented in a programmable logic controller that takes into account various conditions and logic to safely enable or disable or shut down operation. These measures, which can be applied individually or in combination, create physical and/or software-based interlocks that ensure that operation only takes place under safe conditions and that all relevant safety standards are met.

According to a particularly advantageous specific embodiment, which contributes significantly to increasing the operational safety of the construction site mixing machine in the aforementioned sense, it can accordingly be provided that the safety function and/or safety device is formed by a monitoring device or that the safety function and/or safety device described above has a monitoring device. This monitoring device is coupled to the control unit in a signal-transmitting manner and is optionally or preferably also suitable and designed to detect at least the operational mixing tool use position of the at least one mixing tool, for example by sensors and/or by means of at least one switch, and to enable operation of the mixing tool drive unit and/or the mixing container drive unit, preferably with the actuation device activated, for example only when the at least one mixing tool is in the operational mixing tool use position, or to stop it when the at least one mixing tool is no longer in the operational mixing tool use position. Alternatively or additionally, according to a further embodiment, for example as or in conjunction with a bridging device, it can also be provided that at least the mixing tool drive unit can be activated before the operational mixing tool use position is reached, i.e. for example before the mixing tool displacement device is moved downwards. This activation can take place via a manual and/or throttle switch, for example. In this way, the mixing tool can dip into the mixing material during the downward movement while it is already rotating. In this case, it can be provided as a safety function, for example, that the mixing container drive unit can only be activated once the operational mixing tool use position has been reached.

A “monitoring device” in the sense of the present invention is understood to mean all conceivable sensors or switches which, in conjunction with a safety function and/or a safety device, are suitable for monitoring the position or state of a moving component in a system and triggering corresponding signals or actions when a certain position is reached. The term “monitoring device” in the sense of the present invention idea thus includes, on the one hand, all types of switches, including limit switches, which are placed at the end of a movement path. On the other hand, it also includes all types of sensors, such as light barriers, magnetic field sensors or optical sensors, which are used to detect the position of objects or components.

According to a particularly preferred specific embodiment of the present inventive idea, the monitoring device is a component of a mixing tool displacement device described in more detail below, for example a telescoping device as a mixing tool displacement device, as is also described in more detail below. In particular with such a mixing tool displacement device, the respective position of the at least one mixing tool can be monitored particularly easily as a function of the position of the elements which can be displaced relative to one another.

For example, according to a specific embodiment, it can be advantageously provided that the monitoring device has a safety sensor and/or a safety switch, preferably a position switch, which is coupled to the control unit in a signal-transmitting manner. According to a specific embodiment of this, it may again be provided that the safety switch is deactivated in the operational mixing tool use position of the at least one mixing tool, for example in the case of a telescoping device pushed together as a mixing tool displacement device, so that operation of the mixing tool drive unit and/or the mixing container drive unit is enabled or basically enabled. The control unit can then, preferably with the actuation device (e.g. formed by a manual switch) activated at the same time, control or activate the mixing tool drive unit and/or also the mixing container drive unit in the desired, preferably programmed, manner. Furthermore, the safety switch is activated in the non-operational mixing tool use position of the at least one mixing tool, for example when the telescoping device is at least partially extended as a mixing tool displacement device, so that the operation of the mixing tool drive unit and/or the mixing container drive unit is blocked or stopped. In this state, the control unit preferably blocks or stops the actuation of the mixing tool drive unit and/or the mixing container drive unit-even if an actuation device, such as a manual and/or throttle switch, is activated.

As already mentioned many times before, the construction site mixing machine preferably contains a mixing tool displacement device, by means of which the at least one mixing tool, which can be driven in rotation by means of the mixing tool drive unit, can be displaced between a preferably operational mixing tool use position, in which the at least one mixing tool, preferably operational, is accommodated in the receiving space, and a mixing tool non-use position, in which the at least one mixing tool is not in any mixing tool use position, in particular not in any operational mixing tool use position. It is preferably provided here that the mixing tool displacement device has a telescoping device, preferably arranged laterally next to the mixing container and/or projecting upwards in the vertical axis direction, or is formed by such a telescoping device, wherein the at least one mixing tool, preferably together with the mixing tool drive unit, can be displaced by means of the telescoping device between the at least one mixing tool use position and the mixing tool non-use position, as viewed in the telescopic axis direction.

According to a further particularly preferred embodiment of the construction site mixing machines according to the invention, it is provided that the mixing container receptacle has a rotatably mounted receiving element, preferably a rotary platform or rotary platform with a support surface for the mixing container, which receives the mixing container and is coupled to the mixing container drive unit so that it can be driven in rotation, so that the mixing container can be rotated together with the receiving element during the mixing process. A rotatably mounted receiving element ensures that the mixing container rotates evenly during the mixing process. Particularly when the mixing container and mixing tool rotate in opposite directions, a particularly homogeneous and uniform mixing of the materials is achieved.

According to a further particularly preferred specific embodiment, the rotatably mounted receiving element has a preferably flat or level, support surface on which the mixing container can be placed for receiving it in the mixing container holder. The support surface, in particular a flat or level support surface, of the mixing container holder enables simple and precise positioning of the mixing container. Construction workers can easily place the mixing container on the support surface, which simplifies handling and makes the mixing machine ready for use more quickly. In particular, the flat or level support surface also ensures a stable base for the mixing container during the mixing process. This contributes to even rotation and mixing of the materials by avoiding irregularities in the position of the mixing container.

According to a further particularly preferred embodiment, it can also be provided alternatively or additionally that the mixing container holder has a holding device which is suitable and designed to hold the mixing container, preferably the mixing container placed on the support surface, releasably on or on the mixing container holder, preferably releasably and non-positively and/or positively on or on the mixing container holder. In this context, the holding device can, for example, be formed by a clamping device which releasably clamps the mixing container, preferably a lower container area of the mixing container in relation to the vertical axis direction, by means of at least one clamping element. For example, the clamping device can be formed by a clamping ring or by several clamping elements, for example projecting from the mixing container holder in a bracket-like manner, which are arranged, for example, at a distance from each other around the support surface and clamp a lower edge area of the mixing container between them. As an alternative or in addition to such a force-locking or frictionally engaged holding device, a form-fit holding device can be provided in accordance with a particularly preferred embodiment, for example in such a way that at least one engagement element is arranged on the mixing container holder, preferably in the area of the support surface of the mixing container holder, which can be moved in the position of use of the mixing container, i.e. with a mixing container positioned in or on the mixing container holder, cooperates with at least one driver counter element formed on the mixing container, preferably on an underside of the mixing container, for example in the form of a driver lug, which can be molded on there, for example. A specific embodiment is particularly preferred here, in which several engagement elements spaced apart from one another in the circumferential direction and/or several counter-engagement elements spaced apart from one another in the circumferential direction are provided, which ensures that the driver function acts quickly and reliably even when the mixing container drive unit reverses its direction of rotation. This ensures in a simple and reliable way that the mixing container can no longer slip during operation. Such a holding device, in particular a force-fit and/or friction-fit holding device, provides a secure hold for the mixing container. This ensures stable positioning during the mixing process and minimizes possible vibrations and displacements of the mixing container. The holding device thus facilitates the secure attachment and removal of the mixing container from the mixing container holder. Construction workers can load and unload quickly and efficiently, which increases overall productivity.

Further advantageous embodiments of the embodiment according to the independent construction site mixing machine claims, so that reference is made to the explanations therein to avoid repetition.

The invention further relates to a method of operating a construction site mixing machine according to the method claim. The advantages resulting therefrom are identical to the advantages of the construction site mixing machine described above according to any one of the dependent the construction site mixing machine claims, so that reference is made to the foregoing in order to avoid repetition.

The invention further relates to a method for operating a construction site mixing machine according to the independent method claim. The advantages resulting therefrom are identical to the advantages of the construction site mixing machine claims described above, so that reference is made to the previously made explanations in order to avoid repetition.

Other features which are considered as characteristic for the invention are set forth in the appended claims.

Although the invention is illustrated and described herein as embodied in a construction site mixing machine, especially mobile construction site rotary mixing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective side view of an exemplary embodiment of a construction site mixing machine according to the invention, in which a mixing tool is not in an operational mixing tool use position;

FIG. 2 is a schematic partial sectional view of the representation shown in FIG. 1;

FIG. 3 is a front view corresponding to FIG. 1, in which the mixing tool is pivoted into a filling position in which the mixing container is freely accessible for filling and the suction device is in the suction position;

FIG. 4A shows a front view of the construction site mixing machine corresponding to the representation shown in FIG. 3 with a mixing tool pivoted to the mixing tool insertion position, in which the mixing tool is located directly above the outlet opening of the mixing container;

FIG. 4B is a side view corresponding to FIG. 4A;

FIG. 5 is a schematic perspective top view of the construction site mixing machine when transferring the mixing tool to the operational mixing tool use position;

FIG. 6A is a schematic front view of the construction site mixing machine with the mixing tool transferred to the operational mixing tool use position;

FIG. 6B is a side view corresponding to the illustration in FIG. 6A;

FIG. 6C is a perspective top view of the construction site mixing machine corresponding to the representation in FIGS. 6A and 6B with a mixing tool transferred to the operational mixing tool use position;

FIG. 7A is a sectional view of an exemplary embodiment of a safety switch forming part of a safety device in the activated, positively actuated state;

FIG. 7B is a sectional view showing the safety switch in FIG. 7A in the deactivated state;

FIG. 8 is a detailed view of an exemplary embodiment of a locking mechanism with which the telescoping device and thus the mixing tool can be releasably locked in the filling position shown in FIG. 3;

FIG. 9 is a sectional and detailed view of a gas pressure spring of the telescoping device together with a locking and unlocking device in the locked state;

FIG. 10 is a sectional view corresponding to FIG. 9 in the unlocked state;

FIG. 11 is a cross-sectional view of an alternative embodiment with a positive-locking holding device for the mixing container on the mixing container holder;

FIG. 12 is a schematic top view of the basic arrangement of the holding device as shown in FIG. 11;

FIG. 13 is a schematic and perspective bottom view of a section of an alternative construction site mixing machine, in which a throttle switch is coupled to a part of an actuation lever extending outside the upper telescoping element;

FIG. 14 is a schematic and perspective side view of FIG. 13; and

FIG. 15 is a schematic and perspective view of the part of the actuation lever extending inside the upper telescoping element together with an associated stop element and a sensor device.

### DETAILED DESCRIPTION OF THE INVENTION

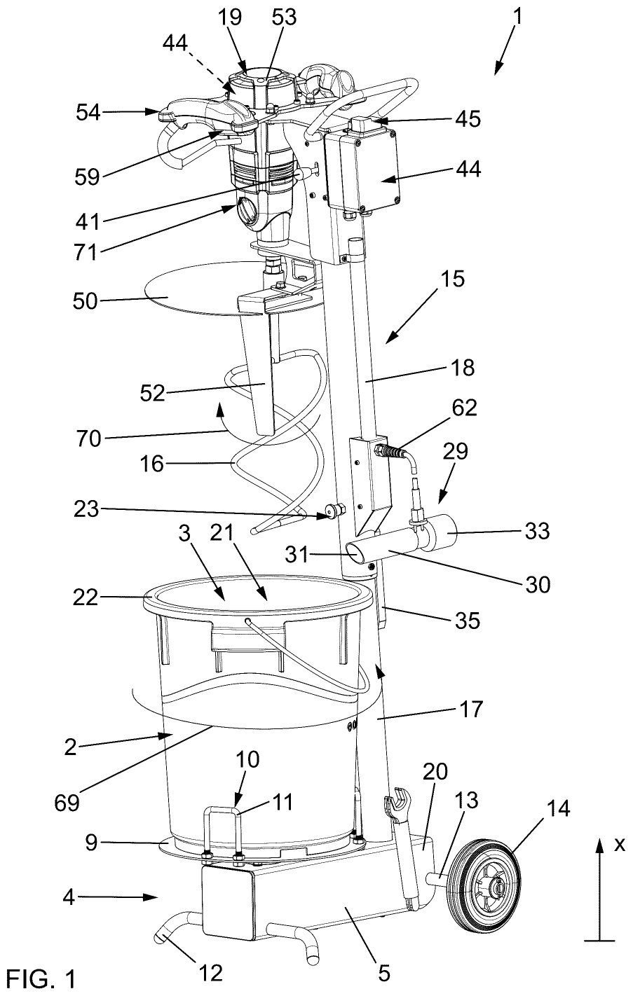

Referring now to the figures of the drawings in detail and first, particularly to FIG. 1 thereof, there is shown a schematic and perspective view of an exemplary embodiment of a construction site mixing machine 1 according to the invention, which is configured here as a movable and thus mobile construction site rotary mixing machine.

The construction site mixing machine here has an upwardly open mixing container 2, which is suitable and designed to hold a mixing material, for example plasters, screeds, concrete, mortar, slurries, resins or the like, in its receiving space 3.

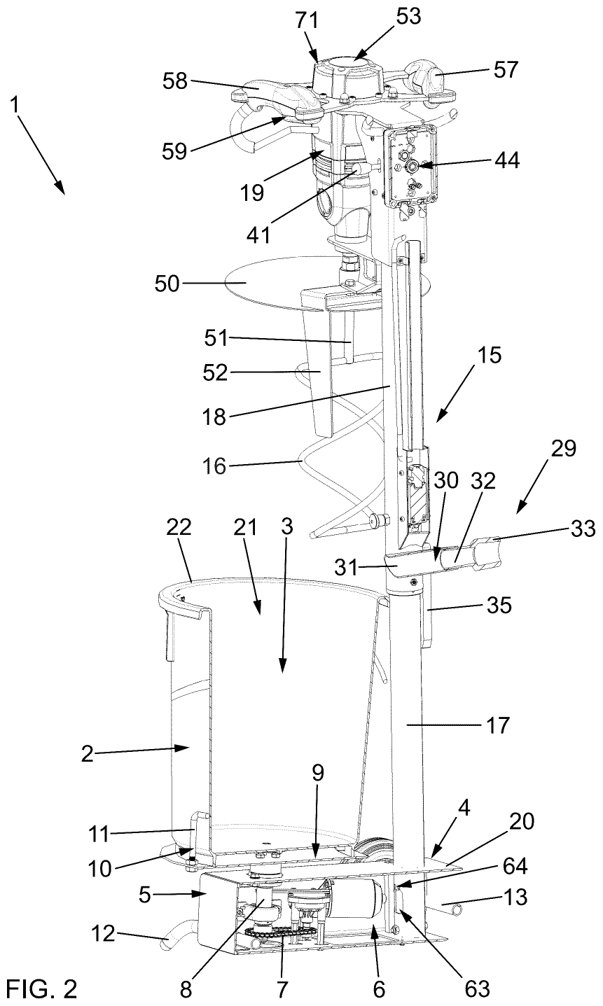

The mixing container is accommodated by a mixing container holder 4, which in this case has a housing part 5 arranged on the base side in relation to the vertical axis direction x, which has an elongated shape and is designed in the form of a box or cuboid. As can be seen in particular from FIG. 2, which shows a sectional view through the lower area of the construction site mixing machine 1, a drive motor forming a mixing container drive unit 6 is accommodated in the housing part 5. In this example, the drive motor drives a rotation axis 8 via a chain 7, which in the example shown here is connected centrally and centrally to the underside of a receiving element 9 formed by a rotary platform. Instead of a chain, any other suitable drive means could of course also be used, for example a toothed belt. The rotary platform is part of the mixing container holder 4 and is rotatably mounted on the housing part 5. For this purpose, the rotation axis 8 extends through the housing part 5.

As can be seen from FIGS. 1 and 2, the rotary platform 9 forms a flat or level support surface on which the mixing container 2 can be placed in the mixing container holder 4.

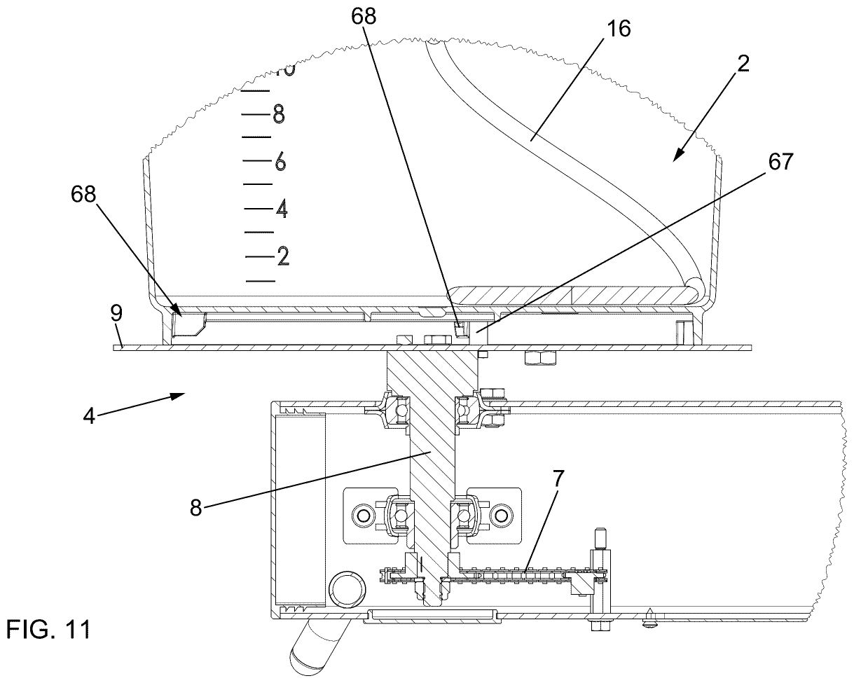

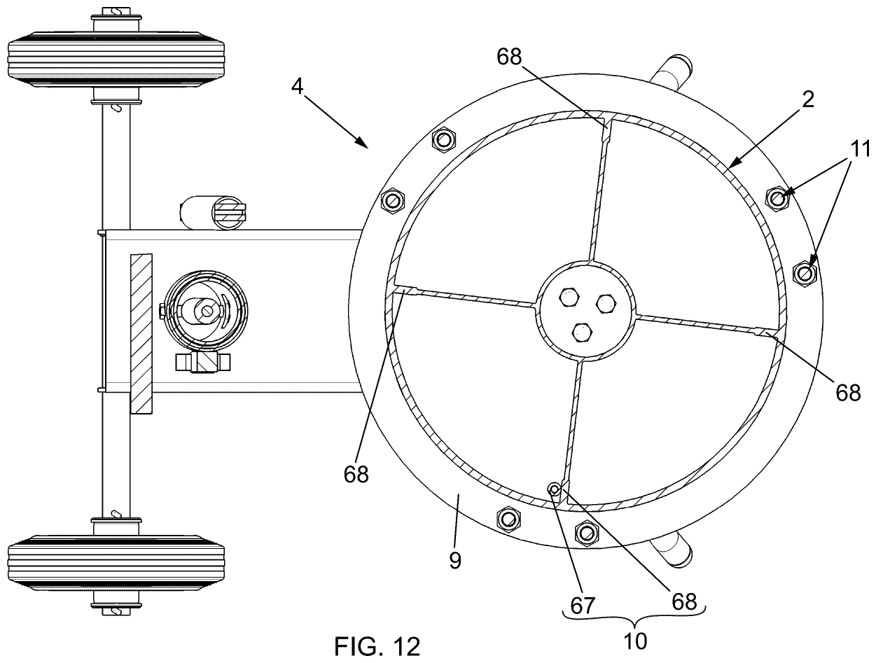

The mixing container 2, here preferably and exemplarily having an essentially circular-cylindrical and downwardly conically tapering shape, is releasably held on the rotary platform 9 by means of a holding device 10, the holding device 10 here being formed merely exemplarily by a plurality of clamping brackets 11 arranged spaced apart from one another on the circumference of the rotary platform 9, which releasably clamp a lower container region of the mixing container 2 with respect to the vertical axis direction x and thereby hold it in the mixing container position shown in FIGS. 1 and 2 in a functionally reliable manner. Alternatively or additionally, as can be seen from FIGS. 11 and 12, it can also be provided that at least one engagement element 67 is arranged on the mixing container receptacle 4, here for example in the area of the support surface of the mixing container receptacle 4, to form a positive-locking holding device 10, which in the shown position of use of the mixing container 2 interacts with at least one counter-engagement element 68 of the mixing container 2. This at least one driver counter-element 68 is preferably arranged on the underside of the mixing container 2 and is furthermore designed here, for example, in the form of a molded-on driver tab. Overall, in the example case shown here, several driver counter elements 68 spaced apart from one another in the circumferential direction are provided, which ensures that the driver function acts quickly and reliably even if the direction of rotation of the mixing container drive unit 6 is reversed. In addition or as an alternative, several engagement elements 67 can also be arranged distributed in the circumferential direction on the mixing container receptacle, but this is not shown here. This ensures in a simple and reliable manner that the mixing container can no longer slip during operation.

The drive unit forming the mixing container drive unit 6 is preferably formed by an electric motor which, as will be described in more detail below, is preferably only actuated when the mixing tool 16 is in an operational mixing tool use position.

The housing part 5 and thus the mixing container holder 4 also has, by way of example only, a support foot 12 on the left-hand, front side of the housing part 5 in the plane of the FIGS. 1 and 2 and a wheel axle 13 with wheels 14 on the opposite, rear, right-hand side of the housing part 5, so that the construction site mixing machine 1 can be parked on a floor surface in a functionally safe and reliable manner in the position of use and can also be moved by means of the wheels 14 if necessary.

As can be seen in particular from FIG. 2, the wheel axle 13 is exposed in the right, rear area of the housing part 5, so that it also forms a carrying handle in a double function, by which the mixing container holder 4 can be gripped, so that the mixing container holder 4 can be comfortably gripped and carried by a user with two hands.

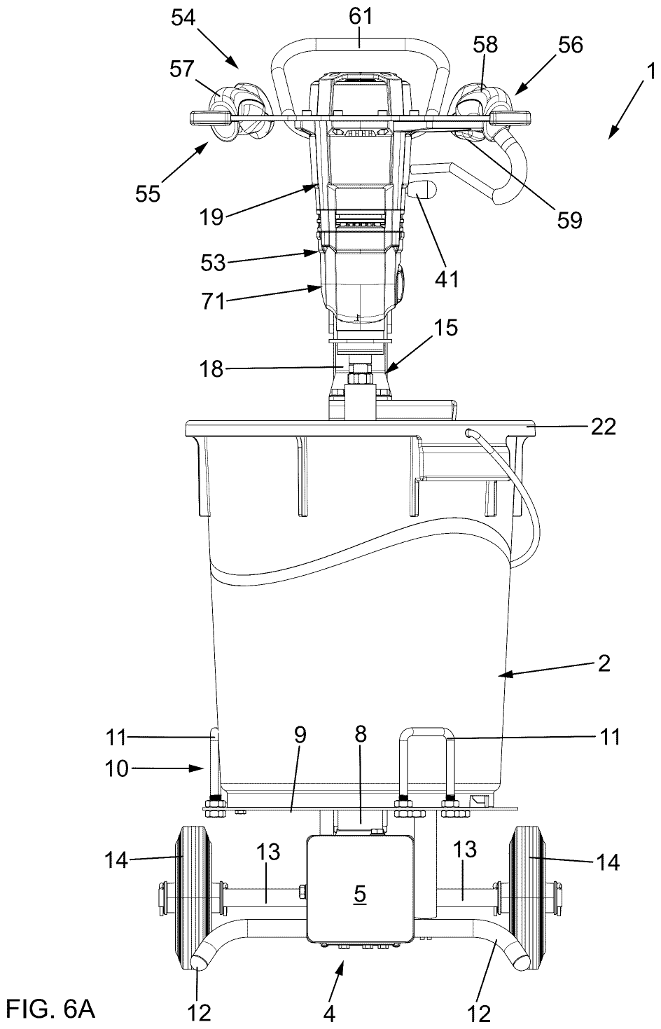

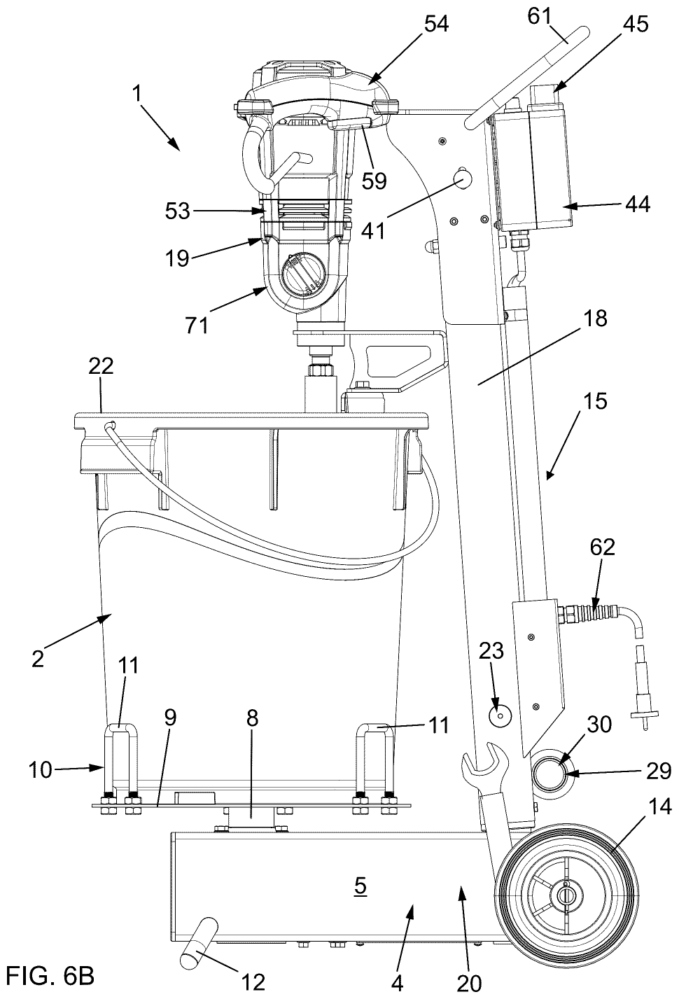

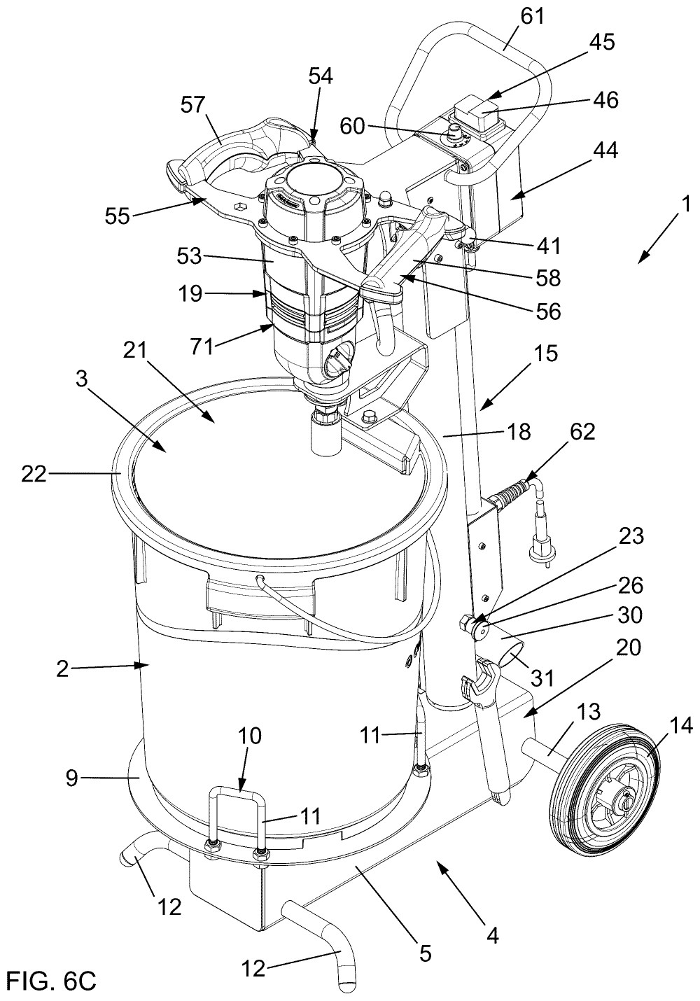

As can be further seen from FIGS. 1 and 2, the construction site mixing machine 1 also has a mixing tool displacement device 15, which is formed here by a telescoping device and by means of which a mixing tool 16 can be moved between a mixing tool use position, which is described in more detail below and is shown in FIGS. 6A, 6B and 6C, in which the mixing tool 16 is received in the receiving space 3 of the mixing container 2 ready for use, and a mixing tool non-use position, which is shown, for example, in FIGS. 1 and 2, in which the mixing tool 16 is located in the receiving space 3 of the mixing container 2 ready for use, in which the mixing tool 16 is held in the receiving space 3 of the mixing container 2 ready for operational use, and a mixing tool non-use position, shown for example in FIGS. 1 and 2, in which the mixing tool 16 is not in the mixing tool use position ready for operational use.

The mixing tool displacement device 15 formed by a telescoping device has, by way of example, two telescoping elements 17, 18 which can be telescoped relative to one another in the telescopic axis direction in relation to the telescoping device, wherein in the example shown here a lower telescoping element 17 which is fixed in the telescopic axis direction is provided, to which an upper telescoping element 18 which can be displaced relative thereto is connected upwards in the telescopic axis direction, fixed telescopic element 17 is provided, to which is connected, upwards in the telescopic axis direction, an upper telescopic element 18 which can be displaced relative thereto and on which the mixing tool drive unit 19, which is described in more detail below, is mounted or arranged together with a mixing tool 16 arranged thereon. arranged on it. In the example shown here, the vertical axis direction x corresponds approximately to the telescopic axis direction of the telescoping device 15, whereby the telescoping device 15 can be inclined slightly forwards towards the mixing container 2 against the vertical axis direction, for example in order to achieve a certain arrangement of the mixing tool 16 in the mixing container 2. Preferably, the inclination is between 1° and 10°, most preferably between 3° and 6°.

Specifically, in the embodiment example shown here, the lower telescoping element 17 projects upwards in the vertical axis direction x from a projection 20 of the housing part 5 that projects laterally beyond the rotary platform 9, possibly also, as already explained, inclined by 1° to 10°, preferably by 3° to 6°, relative to the vertical axis direction, so that the telescoping device 15 forming the mixing tool displacement device 15 projects upwards laterally next to the mixing container in the vertical axis direction x.

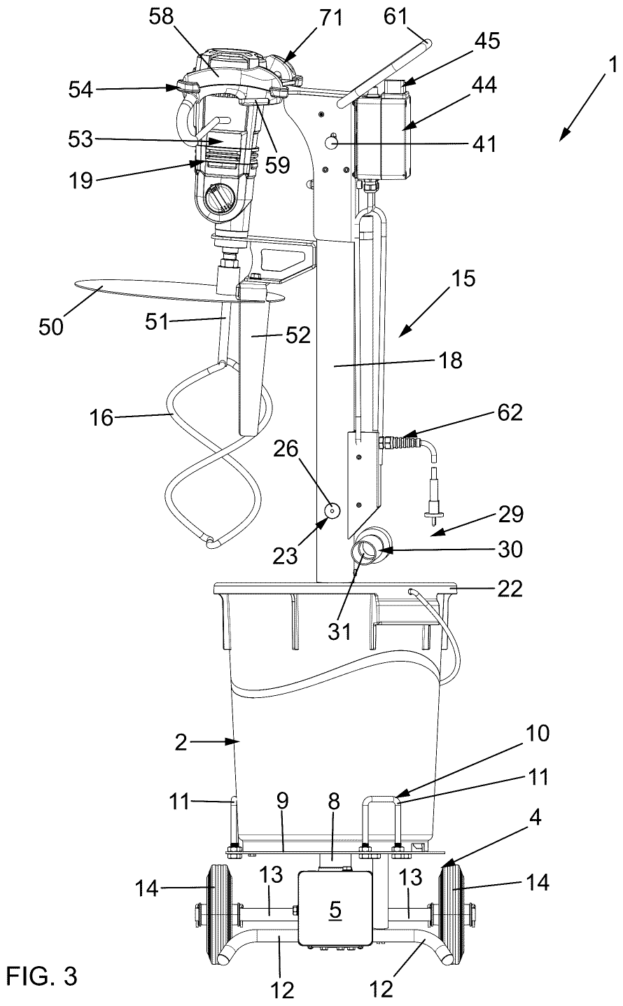

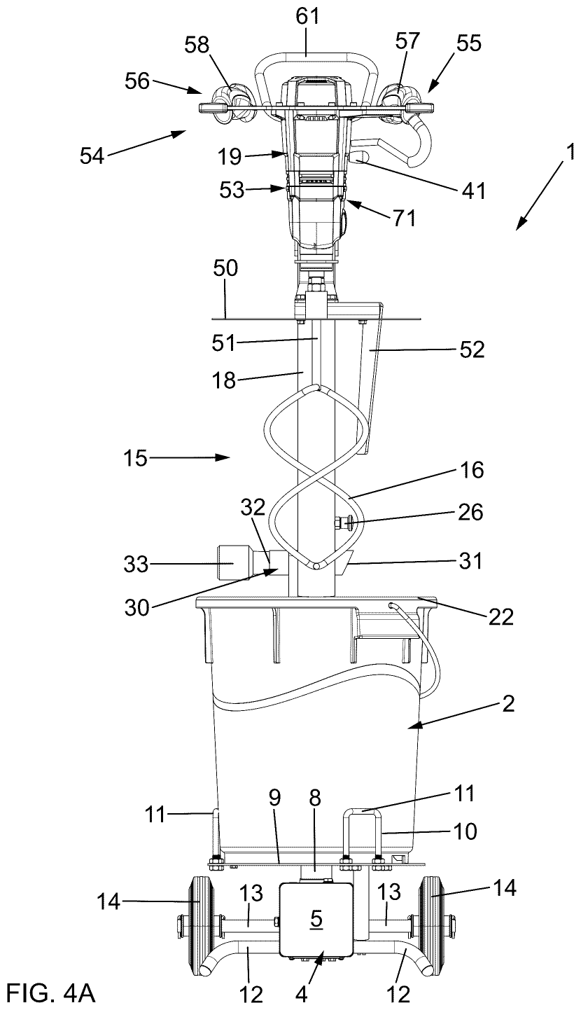

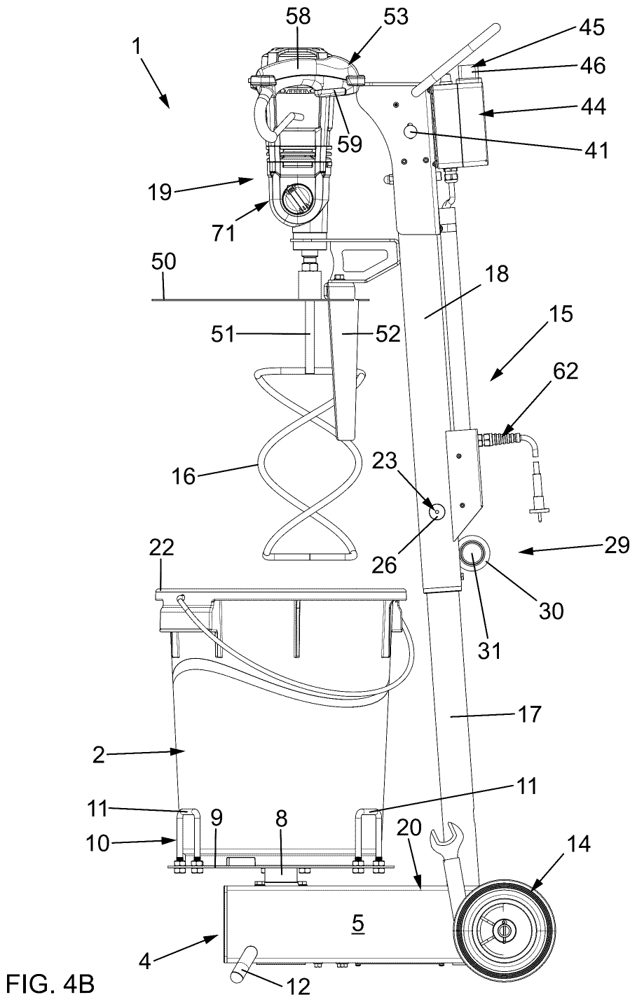

In the extended position of the telescoping device 15 shown in FIGS. 1 and 2, the free lower end of the mixing tool 16 is located in the area above the outlet opening 21 or above the mixing container upper edge 22 of the mixing container 2, in which the upper telescoping element 18 can be rotated or pivoted relative to the lower telescoping element 17 in a horizontal plane about the longitudinal axis of the telescoping device 15. As a result, in this extended position of the telescoping device 15, the mixing tool 16 can be pivoted by means of the upper telescoping element 18 in a horizontal plane lying above the upper edge 22 of the mixing container between a mixing tool insertion position in which the mixing tool 16, as shown in FIGS. 4A and 4B, is located directly above the outlet opening 21 of the mixing container 22 and is prepared for transfer to the operational mixing tool use position, and the filling position shown in FIGS. 1 to 3, in particular FIG. 3, in which the mixing tool 16 is arranged laterally outside the mixing container 2 so that the outlet opening 21 of the mixing container 2 is exposed for unhindered filling thereof.

This pivoting movement in the horizontal plane lying above the upper edge 22 of the mixing container is preferably limited by a pivot angle limiting device, which is formed, for example, by stop elements not shown here between the lower telescoping element 17 and the upper telescoping element 18 and by means of which a first maximum pivot position is defined, which essentially corresponds to the mixing tool insertion position shown in FIG. 4A, and a second maximum pivot position is defined, in which the mixing tool 16 is arranged laterally outside the mixing container 2, preferably pivoted outwards by approximately 95° away from the mixing tool insertion position, as can be clearly seen in FIG. 3, for example.

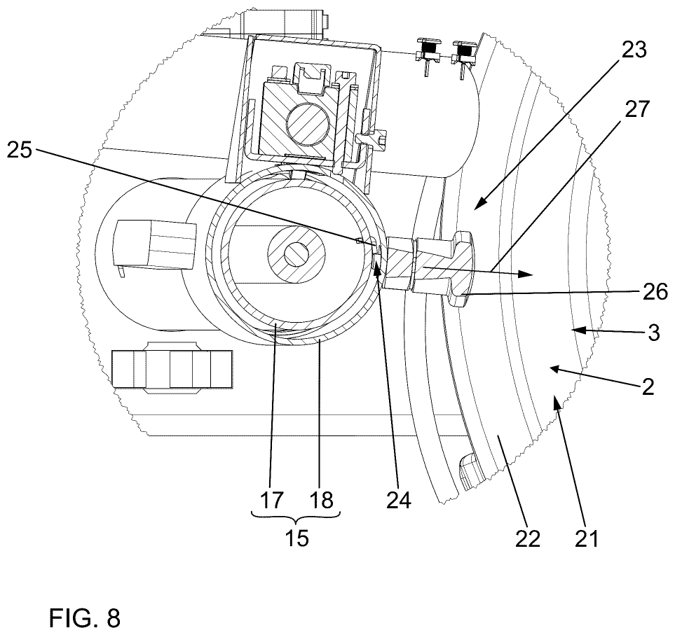

In order to ensure that the upper telescoping element 18 cannot be pivoted back towards the mixing tool insertion position in the filling position shown in FIG. 3 in an undesirable manner, a locking mechanism 23 (see FIG. 8) can be provided, which is designed here as a releasable latching and/or snap connection and in which a latching element 24 of the upper telescoping element 18, which is pretensioned in the direction of latching engagement by means of a pretensioning element not shown here, for example a spring element, is released after a predetermined pivoting path of the upper telescoping element (relative to the mixing tool insertion position), element 24 of the upper telescoping element 18, which is pretensioned in the direction of latching engagement by means of a spring element not shown here, after a predetermined pivoting path of the upper telescoping element (relative to the stationary, lower telescoping element 17) snaps behind a latching counter element 25 of the lower telescoping element 17 and latches releasably there. The latch element 24 is coupled here, for example, to an actuating element 26 in the form of a hand knob, by means of which the latch element 24 can be brought out of latching engagement with the latch counter-element for unlocking against the force of the (not shown) pretensioning element. In a particularly simple embodiment, this is achieved by the operator pulling with his hand in the direction of the arrow 27 in FIG. 8.

As can be seen particularly clearly from FIGS. 1 to 3, the actuating element 26 formed by the hand knob is arranged in a lower region of the upper telescoping element 18 in such a way that it is easily and freely accessible in the filling position.

Alternatively or additionally, it may also be provided that the latch element can be disengaged from the latch counter element 25 by displacing the upper telescoping element 18 upwards or downwards in the telescopic axis direction or in the vertical axis direction x. In both cases, it is ensured in any case that after unlocking, pivoting of the upper telescoping element 18 in this height position of the upper telescoping element 18 in the direction back to the mixing tool insertion position (see FIG. 4A) is enabled.

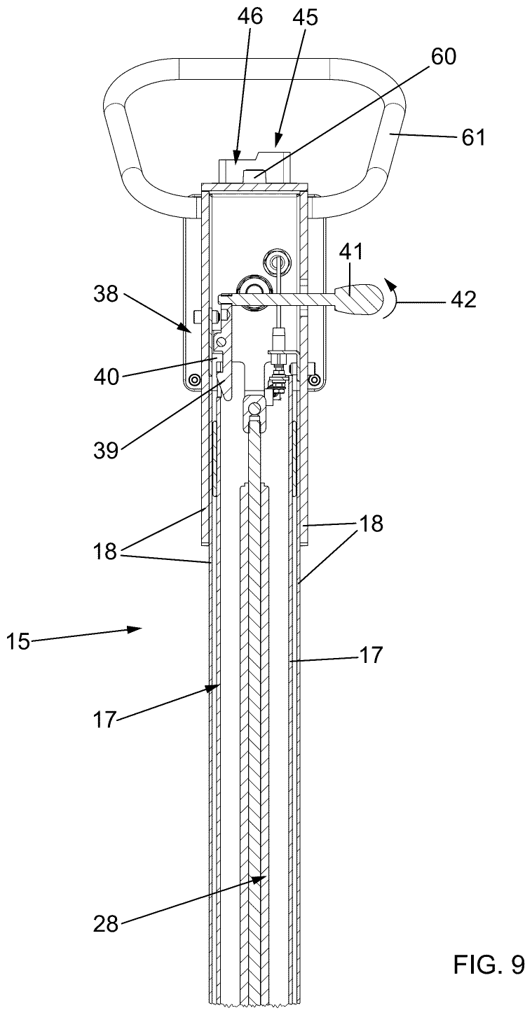

As can be seen in particular from FIG. 9, the telescoping device 15 furthermore has a gas pressure spring 28 as an elastic pretensioning element, by means of which the telescoping device 15 or the lower telescoping element 17 and the upper telescoping element 18 can be pretensioned in the extended position, so that the telescoping device 15 can be reliably held in the extended position by means of the gas pressure spring 28. The lower telescoping element 17 and the upper telescoping element 18 can be pretensioned into the extended position, so that the telescoping device 15 can be held in the extended position in a functionally reliable manner by means of the gas pressure spring 28 and can only be transferred into the operational mixing tool use position shown in FIGS. 6A, 6B and 6C against the pretensioning force of the gas pressure spring 28.

A suction device 29 is arranged on the upper telescoping element 18 or in a lower region of the upper telescoping element 18 with respect to the vertical axis direction x, by means of which a suction material, for example dust, which accumulates in the region of the outlet opening 21 can be extracted. For this purpose, it is provided that the suction device 29 has a suction tube 30, here exemplarily a suction tube 30 open on both sides and/or formed by a straight pipe section.

In the extended position of the telescoping device 15, the first suction pipe opening 31 of the suction pipe 30 is located in the area above the upper edge 22 of the mixing container, in particular directly above the upper edge 22 of the mixing container. In contrast, in the suction position shown in FIGS. 1 to 3, which corresponds to the filling position of the mixing container, the first suction pipe opening 31 is aligned in the direction of the outlet opening 21 of the mixing container 2. In contrast, a second suction pipe opening 32 opposite the first suction pipe opening 31 is coupled to a suction device 33, shown here only very schematically, for example to a vacuum cleaner or the like. Overall, such a suction device 29 thus achieves reliable and functionally safe dust extraction during filling of the mixing container 2 with a mixing material.

As can be seen very clearly from FIGS. 1 and 2, the first suction pipe opening 31 is beveled, here only exemplarily with a bevel angle of approximately 25°, whereby on the one hand the suction surface is enlarged and on the other hand the mixing container 2 cannot get caught on the suction pipe 30 during removal.

In order to ensure that the mixing tool 16 can be lowered by means of the upper telescopic element 18 only in the mixing tool insertion position shown in FIG. 4A and in FIG. 4B, in which the mixing tool 16 is located directly above the outlet opening 21 of the mixing container 2, in the direction of the operational mixing tool use position, a forced displacement device can be provided which releases the lowering of the upper telescopic element 18 only in the mixing tool insertion position shown in FIGS. 4A and 4B. This is not shown here in detail, but can, for example, be formed by a guided displacement device which has a first guided displacement element arranged or formed on the lower telescoping element 17, for example a guide link, which interacts with a second guided displacement element arranged and formed on the upper telescoping element 18, for example in a sliding block positively guided in the guide link.

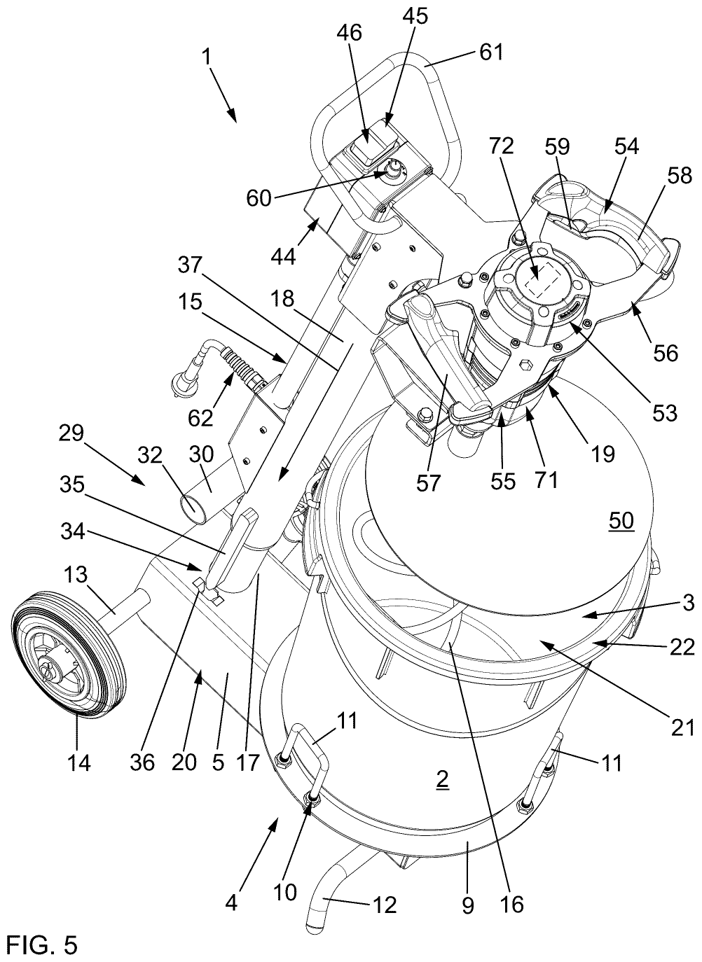

Alternatively or additionally, as shown here as an example in connection with FIG. 5, a guided displacement device 34 can be provided, which is formed by a centering sword 35 arranged on the upper telescoping element 18, which projects from a lower end region of the upper telescoping element 18 facing the mixing container receptacle 4, and a centering recess 36 on the upper side of the housing part 5 of the mixing container receptacle 4. As can be seen very clearly from FIG. 5, when the upper telescopic element 18 is lowered (arrow 37) after a defined lowering path of the upper telescopic element 18, the centering sword 35 engages in the centering recess 36 on the mixing container receptacle 4 or on the housing part 5 in a shape- and/or contour-adapted manner, so that the upper telescopic element 18 can be transferred into the mixing tool use position shown in FIGS. 6A to 6C in a non-rotatable and positively guided manner at least towards the end of the lowering process.

As can be seen from FIG. 5 in particular, the lower telescopic element 17 is accommodated in the upper telescopic element 18 when pushed together in the design example shown here and is thus reliably and functionally protected against soiling.

In the mixing tool use position shown in FIGS. 6A to 6C, the telescoping device 15 or, more specifically, the displacement of the upper telescoping element 18 relative to the lower telescoping element 17 is locked or releasably locked by means of a locking mechanism 38 (see FIG. 9).

As can be further seen from FIG. 9, the locking mechanism 38, which is formed for example by a spring-loaded locking mechanism, has in the example shown here a latch element 39 formed on the upper telescoping element 18, which in the locking position shown in FIG. 9 is releasably locked with a latch counter element 40 of the lower telescoping element 17. In the embodiment example shown in FIG. 9, the latch element 39 formed on the upper telescoping element 18, here exemplarily a latching hook, is pivotably mounted on the upper telescoping element 18 against the force of a spring not shown here, that, when the upper telescoping element 18 is lowered, it snaps behind the latching counter element 40, here exemplarily a latching groove, and thus releasably locks the mixing tool 16 in the pushed-together position of the telescoping device 15 in the desired operational mixing tool use position. Accordingly, the locking position of the locking mechanism 38 is designed and adapted substantially exactly and precisely to the operational mixing tool use position or collapsed position of the telescoping device 15.

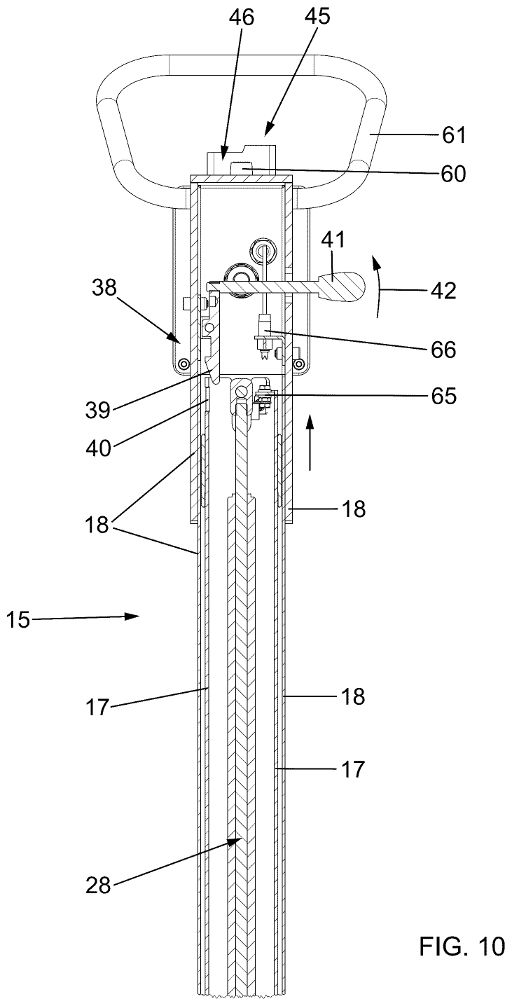

As can be further seen from FIG. 9, the latch element 39 of the locking mechanism 38 is also coupled to a lever which forms an unlocking element of an unlocking device and when actuated (lifting in the direction of the arrow 42) the latch element 39 is displaced, in the example shown here pivoted, in such a way that it is disengaged from the latch counter element 40, whereby the upper telescoping element 18 is moved by means of the gas pressure spring 28 out of the operational mixing tool use position as shown in FIGS. 6A to 6C, that it comes out of engagement with the latching counter element 40, whereby the upper telescoping element 18 is displaced by means of the gas pressure spring 28 from the operational mixing tool use position, as shown in FIGS. 6A to 6C, back upwards (see FIGS. 1 to 5) towards the extended position of the telescoping device 15, as also shown in FIG. 10.

Furthermore, the construction site mixing machine 1 according to the invention has an electronic control unit 44 which electronically controls the activation and deactivation of the mixing tool drive unit 19, the control unit 44 being coupled here, by way of example, to an actuation device 45 by means of which the control unit 44 can be activated and, if necessary, deactivated. As can be seen in particular from FIG. 5 and FIG. 6C, which each show perspective top views of the construction site mixing machine 1, the actuation device 45 is coupled here, for example, to a main switch 46 acting as an on/off switch, or has this switch, which enables operation of the construction site mixing machine 1 when switched on and blocks operation of the construction site mixing machine 1 when switched off.

The construction site mixing machine 1 also has a safety device 43 which is suitable and designed to enable operation of the mixing tool drive unit 19 with the main switch 46 switched on when the mixing tool 16 is in the operational mixing tool use position shown in FIGS. 6A to 6C and also, at least in the embodiment example shown here, furthermore, the telescoping device 15 is also releasably locked by means of the locking mechanism 38, or to lock if the mixing tool 16 is not in the operational mixing tool use position shown in FIGS. 6A to 6C and furthermore, at least in the embodiment example shown here, the telescoping device 15 is not releasably locked by means of the locking mechanism 38. This also expressly includes the case in which operation is stopped when the mixing tool 16 is moved out of the operational mixing tool use position.

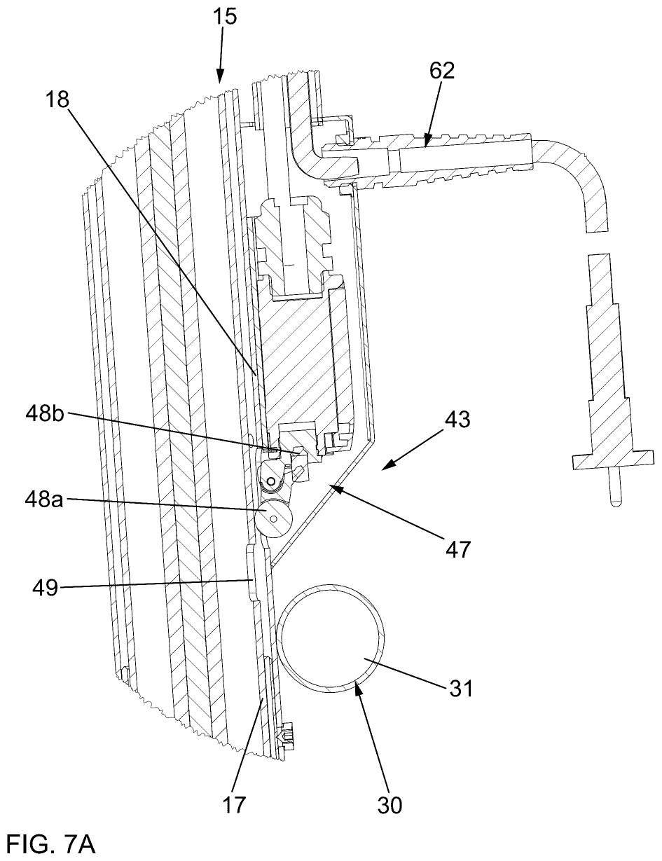

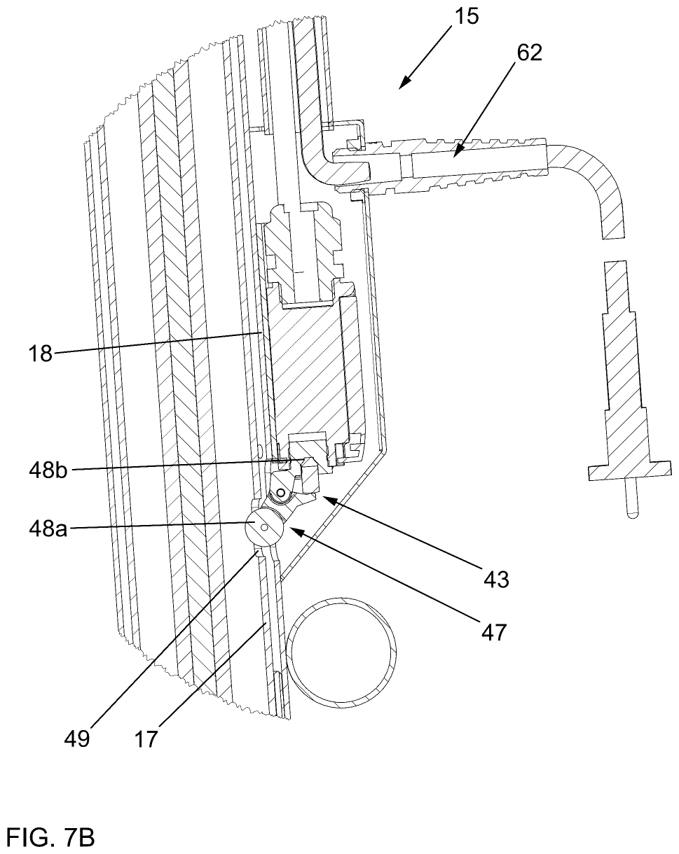

For this purpose, the safety device 43, as shown only extremely schematically and as an example in FIGS. 7A and 7B, can specifically have a safety switch 47 as a monitoring device, which is coupled to the control unit 44 in a signal-transmitting manner. As can be seen from the combined view of FIGS. 7A and 7B, the safety switch 47 is deactivated in the operational mixing tool use position of the mixing tool 16 (FIG. 7B) and thus when the telescoping device 15 is pushed together, so that both the operation of the mixing tool drive unit 19 and the operation of the mixing container drive unit 6 are enabled. Specifically for this purpose, the safety switch 47 can have a spring-loaded switch element 48a which is pivotably mounted on the upper telescoping element 18 and which is displaced into a groove recess 49 on the lower telescoping element 17 in the pushed-together position of the telescoping device shown in FIG. 7B, which corresponds to the operational mixing tool use position, so that the switch element 48a is brought out of contact with a mating contact element 48b and thus the safety switch 47 is deactivated.

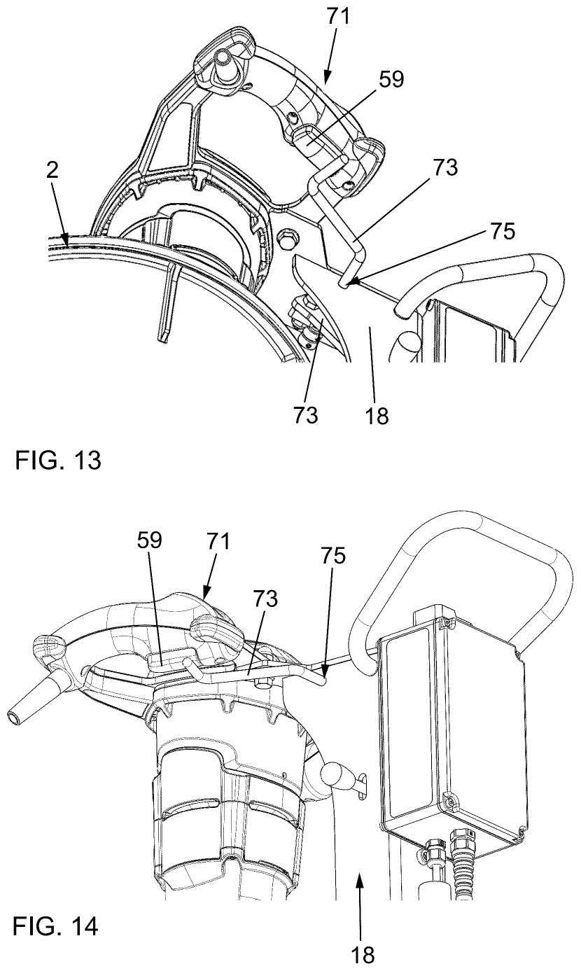

If the upper telescoping element 18 is now displaced upwards relative to the lower telescoping element 17, as shown in FIG. 7A, the switch element 48a is also simultaneously moved out of the groove recess 49 and brought into contact with the mating contact element 48b by its pivot bearing, whereby the safety switch 47 is activated and the operation of the mixing tool drive unit 19 and the mixing container drive unit 6 is blocked. It should be understood that the specific embodiment of a safety switch 47 shown here as a monitoring device is only one of many possibilities for designing such a safety switch or position switch. As an alternative or in addition, other sensory or non-sensory monitoring devices can of course also be provided, which for example work with optical sensors, such as light barriers or the like, which will be explained in more detail below in connection with FIGS. 13 to 15.

The control unit 44 is suitable and designed, preferably memory-programmable, so that the mixing tool drive unit 19 and the mixing container drive unit 6 can be operated together but in opposite directions, i.e. in different directions of rotation, when the main switch 46 is switched on and/or the actuation device 45 is activated. In different directions of rotation, i.e. that both the mixing container 2 and the mixing tool 16 are driven in different directions of rotation by means of their respective drive units, for example the mixing container 4 is driven in a first direction of rotation 69 and the mixing tool 16 is driven in a second, opposite or counter-rotating direction of rotation 70 (see FIG. 1). In this case, the mixing container 4 can be driven by the mixing container drive unit 6 at a speed of approximately 5 to 40 min⁻¹, preferably of approximately 8 to 35 min⁻¹, in the first direction of rotation 69 and the mixing tool 16 can be driven by the mixing tool drive unit 19 at a speed of 250 to 900 min⁻¹, preferably of 300 to 800 min⁻¹, in the second direction of rotation 70, which is opposite to the first direction of rotation 69.

In the embodiment example shown here, the control unit 44 further preferably has a timer function by means of which the operating time of the mixing tool drive unit 19 and the mixing container drive unit 6 can be set and/or controlled. Specifically, the control unit 44 has for this purpose, for example, a timer device with a timer function which is suitable and designed to count down an adjustable and/or predeterminable period of time and to automatically deactivate the mixing tool drive unit 19 and the mixing container drive unit 6 after this period of time has elapsed. The control unit 44 can preferably be programmed in such a way that the mixing tool drive unit 19 is activated before the mixing container drive unit 6, for example the mixing tool drive unit 19 is activated approximately 0.5 seconds to 5 seconds before the mixing container drive unit 6.

The safety device 43 or the safety switch 47 can be used, for example, to ensure that operation of the mixing container drive unit 6 and/or operation of the mixing tool drive unit 19 is only enabled when the mixing tool 16 is in the operational mixing tool use position shown in FIGS. 6A to 6C, in which, at least in the exemplary embodiment shown here, the telescoping device 15 is also releasably locked by means of the locking mechanism 38.

The telescoping device 15 also has a cover element 50, which is formed here by a cover disk which, as can be seen in particular from the combined view of FIGS. 1 and 6C, is arranged on the upper telescoping element 18 and can be displaced together with the latter, so that the cover element 50 essentially completely closes the outlet opening 21 of the mixing container 2 in the operational mixing tool use position (see FIG. 6C). FIG. 6C in particular shows that no finger access into the receiving space 3 of the mixing container 2 is possible or that a gap is formed between the peripheral edge region of the cover element 50 and a container wall region adjoining the cover element 50, here essentially formed by the upper edge 22 of the mixing container.

The mixing tool drive unit 19 is formed here, for example, by a drive motor, preferably an electric motor, whose drive shaft drives the mixing tool 16 in rotation. As can be seen particularly clearly from FIGS. 3, 4B and 5, the cover element 50 formed by the cover disk is arranged locally between the mixing tool 16 and the mixing tool drive unit 19, so that the drive shaft or, as in the example shown here, a connecting part 51 of the mixing tool 16 that can be connected to the drive shaft is guided through the cover element 50.

The cover element 50 also has an elongated, pin and strip-like edge wiper 52, which in the operational mixing tool use position projects into the receiving space 3 of the mixing container 2 and is spaced there from the inner wall of the receiving space by a defined gap distance.

The mixing tool drive unit 19, exemplified here by a drive motor, is accommodated in a drive unit housing 53, which is arranged on the upper telescoping element 18 in the area above the cover element 50.

As can be seen particularly clearly from FIG. 5, the drive device housing 53 has a handle device 54 which, in the example shown here for two-handed operation, has two approximately U-shaped handle elements 55, 56 which are located on opposite sides of the drive device housing 53 as seen transversely to the vertical axis direction x and which each have a handle 57, 58 spaced apart from the drive device housing 53. By means of these two handles 57, 58, the drive device housing 53 can be gripped comfortably with two hands and the upper telescoping element 18 can be pressed downwards in the direction of the arrow 37 shown in FIG. 5 against the force of the gas pressure spring 28 towards the operational mixing tool use position.

As shown for example in FIG. 3 only schematically and in principle, a manual switch 59 can be provided on the handle 58, which can form a bridging device or be a component of a bridging device, whereby it can preferably and optionally be provided that the bridging device is coupled to the control device 44 in such a way that the mixing tool drive device 19 can be activated for a drive of the mixing tool 16 when the manual switch 59 is actuated, that the bridging device is coupled to the control unit 44 in such a way that the mixing tool drive unit 19 can be activated for a drive unit of the mixing tool 16 when the manual switch 59 is actuated, even if the at least one mixing tool 16 is not in the operational mixing tool use position. In this way, the mixing tool 16 can be immersed in the mixing material while rotating during its downward movement. Alternatively, however, the following could also be provided: If the mixing tool 16 is in the operational mixing tool use position, the drive unit of the mixing tool drive unit 19 is blocked, so that the mixing tool drive unit 19 cannot (any longer) be activated in the operational mixing tool use position by means of the bridging device.

As can be seen further from FIG. 5, the control unit 44 can be coupled to a time selector switch 60, by means of which different operating times of the mixing tool drive unit 19 and the mixing container drive unit 6 can be set. For example, mixing times from 15 seconds to 10 minutes, preferably from 0.5 minutes to 5 minutes, can be set here, whereby the setting can be continuous or staggered. The control unit 44 is programmed, for example, so that the mixing tool drive unit 19 and the mixing container drive unit 6 are automatically deactivated after the set period of time has elapsed and are thus no longer driven. Similarly to activation, deactivation can also take place simultaneously or with a time delay.

As can be seen particularly clearly from the combined view of FIGS. 6B and 6C, a handle element 61 is provided at an upper free end region of the upper telescoping element 18, which is designed here merely by way of example as a bow handle and projects from the upper telescoping element in such a way that it projects rearwardly beyond the control unit 44, relative to the image plane of FIG. 6B. As a result, the construction site mixing machine 1 can be tilted from the upright position shown in FIG. 6B, for example by 90° to the right, and brought into a lying position in which the construction site mixing machine 1 is supported on the ground on the one hand by the wheels 14 and on the other hand by the handle element 61, without the control unit 44 touching the ground. Obviously, this also provides fall protection for the control unit 44.

Alternatively, however, the control unit 44 can also, as shown in dashed lines in FIG. 1, together with the mixing tool 16 and the mixing tool drive unit 19, be part of a manual mixing unit 71 which has the handle unit 54 and the drive unit housing 53 and which, in a particularly preferred embodiment, forms a separate component which is detachably mounted on the construction site mixing machine 1 or, in the specific example shown here, on the upper telescopic element 18 of the telescopic element 15 as a mixing tool displacement device. In the specific example shown here, to the upper telescoping element 18 of the telescoping element 15 as a mixing tool displacement device. As a result, the manual agitator 71 can advantageously also be used separately and independently of the construction site mixing machine 1. In this embodiment variant, the actuation device 45 can then have, in addition to the main switch 46 in the example case shown here, a throttle switch formed by the hand switch 59, which is arranged on the handle device 54. In this embodiment, a time selection device can also be provided, by means of which at least the operating time of the mixing tool drive unit 19, and possibly also of the mixing container drive unit 6, can be preset. The input can then be made, for example, via a display 72 (indicated by a dotted line in FIG. 5).

As can be seen in particular from FIGS. 13 to 15, which show an alternative embodiment, the actuation device 45 in the embodiment shown here can comprise a throttle switch, which is formed here, for example and preferably, by the manual switch 59. It is typically located in the area of a handle of the mixing machine 1, here exemplarily in the area of the handle 58, and can be actuated manually by pressure. This throttle switch 59 can be used, for example, to activate the mixing tool drive unit 19 and regulate its speed, for example by increasing pressure on the throttle switch.

The actuation device 45 here additionally contains a mechanical actuation lever 73, which interacts with the throttle switch 59 in such a way that a continuous operation mode of the mixing tool drive unit 19 is set and/or activated when the operational mixing tool use position is reached.

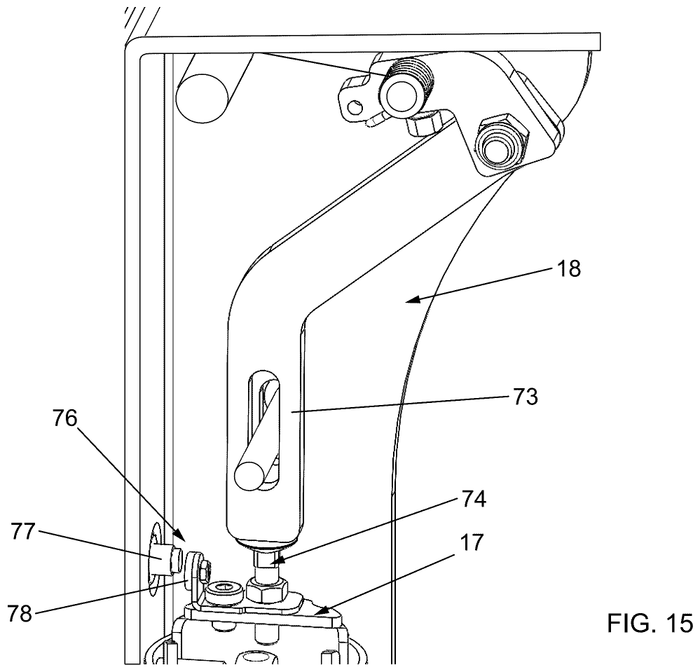

In the example shown, the actuation lever 73 is arranged on the upper telescoping element 18, wherein the actuation lever 73 or a part of the actuation lever 73 extending inside the upper telescoping element 18 and a stop element 74 on the lower telescoping element 17 is assigned to the actuation lever 73 or a part of the actuation lever 73 extending inside the upper telescoping element 18, against which the actuation lever 73 comes to a stop after a defined displacement path when the mixing tool 16 is displaced into the mixing tool use position (see FIG. 15), so that the actuation lever 73, during the further displacement of the mixing tool 16 into the mixing tool use position, is pivoted by means of the pivotable bearing 75 on the upper telescoping element 18 and the actuation lever 73 or preferably a part of the actuation lever 73 extending outside the upper telescoping element 18 actuates or presses the throttle switch 59. In the embodiment shown here, the actuation lever 73 acts directly on the throttle switch 59. The mechanical actuation of the throttle switch ensures that the continuous operation mode is only activated in the correct position, i.e. in the operational mixing tool use position. The actuation lever 73 and the throttle switch 59 can also optionally be equipped with a return spring, which ensures that the actuation lever or the switch is automatically returned to the rest and starting position when the mixing tool is moved out of the operational mixing tool use position again, which then preferably at least stops the operation of the mixing tool drive unit 19.

FIG. 15 also schematically shows an alternative embodiment of the safety device 43, which here is sensor-based and has a sensor device 76, which is connected to the control unit 44 in a signal-transmitting manner. The sensor device 76 comprises a first sensor element 77, which is arranged on the upper telescoping element 18, and a second sensor element 78, which is arranged on the lower telescoping element 17. The two sensor elements 77 and 78 work together to detect whether the mixing tool 16 is in the operational mixing tool use position. Only when the mixing tool 16 has reached this position is a corresponding signal sent from the sensor unit 76 to the control unit 44. This signal causes the sensor device 76 to be activated, thereby enabling operation of both the mixing tool drive unit 19 and the mixing container drive unit 6.

If, on the other hand, the mixing tool 16 is not in the operational mixing tool use position, the sensor device 76 remains deactivated. This blocks the operation of both the mixing tool drive unit 19 and the mixing container drive unit 6. The sensor device 76 can be formed here, for example, by inductive proximity sensors, Hall effect sensors or optical sensors.

As can be seen very clearly from FIGS. 6B and 6C, a cable connection 62 is provided on the rear side of the upper telescoping element 18, in this example above the suction tube 30, via which the two drive units 6, 19, preferably formed by electric motors, as well as the control unit and all electronic functional units and components of the construction site mixing machine 1 can be supplied with energy or current. For this purpose, an energy storage element, for example an accumulator or the like, may also be provided in the area of the cable connection 62.

The cable or line routing is preferably protected on or inside the telescoping device 15 and the mixing container holder 4.

For electrical contacting of the mixing container drive unit 6 formed by an electric drive motor, a first contact element 63 in the form of a contact pin can also be arranged in the area of the mixing container holder 4, preferably in the housing part 5, according to an optional embodiment, as can be seen in particular from FIG. 2, which, in the event that the upper telescoping element 18 is lowered so far downwards that the mixing tool 16 is in the operational mixing tool use position, is in contact with a first mating contact element (not shown here) arranged on the upper telescoping element 18 and is connected to the control unit 44 in a signal-transmitting manner. Furthermore, a further, second contact element 64 can also be provided, which can be brought into contact in an analogous manner with a further, second mating contact element (also not shown here) arranged on the upper telescoping element 18 in order to connect it to the cable connection 62 in an energy-transmitting manner. The contact elements 63, 64 with their correspondingly assigned mating contact elements thus form a further safety element which ensures that the mixing container drive unit 6 can only be operated when the mixing tool 16 has been displaced into the correct desired mixing tool use position by means of the upper telescoping element 18. This type of contact or contact transmission also has the advantage that no trailing cable needs to be carried along during the vertical movement in the x-direction.

As shown in FIGS. 9 and 10, a further contacting point can also optionally be provided in the area of the locking mechanism 38, which is formed here by a contact element 65, which is arranged on the lower telescoping element 17 and which, in the mixing tool use position shown in FIG. 9, is in contact with a contact element 66 arranged on the upper telescoping element 18, which here is only formed by a spring-loaded contact pin, is in contact with a contact element 66 arranged on the upper telescoping element 18, which is only formed here as an example by a spring-loaded contact pin, so that the power supply to the mixing container drive unit 6 is also only ensured when the locking mechanism 38 is locked. In contrast, in the unlocked position shown in FIG. 10, which corresponds to the mixing tool non-use position, the contact element 65 of the lower telescoping element 17 is out of engagement or out of contact with the mating contact element 66 arranged on the upper telescoping element 18, so that the power supply to the mixing container drive unit 6 is interrupted. Here, too, the contact element 65 and the counter-contact element 66 thus again form a further safety element which ensures that the mixing container drive unit 6 can only be operated when the mixing tool 16 has been displaced into the correct desired mixing tool use position by means of the upper telescopic element 18. Again, this type of contact or contact transmission has the advantage that no trailing cable has to be carried along during the vertical movement in the x-direction.

The following is a summary list of reference numerals and the corresponding structure used in the above description of the invention:
1 Construction site mixing machine
2 Mixing container
3 Receiving space
4 Mixing container holder
5 Housing part
6 Mixing container drive unit/drive motor
7 Chain
8 Rotation axis
9 Receiving element/rotary platform
10 Holding device
11 Clamping bracket
12 Support foot
13 Wheel axle
14 Wheels
15 Mixing tool displacement device/telescoping device
16 Mixing tool
17 Lower telescopic element
18 Upper telescopic element
19 Mixing tool drive unit/drive motor
20 Protrusion
21 Outlet opening
22 Top edge of mixing container
23 Locking mechanism
24 Latch element
25 Resting counter element
26 Actuating element
27 Arrow
28 Gas strut/pretensioning element
29 Suction device
30 Suction tube
31 First suction pipe opening
32 Second suction pipe opening
33 Suction device
34 Guided displacement device
35 Centering sword
36 Centering recess
37 Arrow
38 Locking mechanism
39 Latch element
40 Locking counter element
41 Lever
42 Arrow
43 Safety device
44 Control unit
45 Actuation device
46 Main switch
47 Safety switch/monitoring device
48 a Switch element
48 b Mating contact element
49 Groove recess
50 Cover element/cover disk
51 Connecting part
52 Edge wiper
53 Drive unit housing
54 Handle device
55 Handle element
56 Handle element
57 Handle
58 Handle
59 Hand control/gas control
60 Timer switch
61 Handle element
62 Cable connection/power connection
63 Contact element
64 Contact element
65 Contact element
66 Mating contact element
67 Engagement element
68 Driver counter element
69 First direction of rotation
70 Second direction of rotation
71 Hand mixer
72 Display
73 Actuation lever
74 Stop element
76 Sensor device
77 First sensor element
78 Second sensor element

1. A construction site mixing machine for mixing mixing materials, comprising:
an upwardly open mixing container having a receiving space and configured to receive a mixing material in said receiving space;
at least one mixing tool;
a mixing tool drive unit; and
a mixing tool displacement device, by means of said mixing tool displacement device said at least one mixing tool, which is actuatable by means of said mixing tool drive unit, is displaceable between at least one mixing tool use position, in which said at least one mixing tool is received in said receiving space, and a mixing tool non-use position, in which the at least one mixing tool is not in any mixing tool use position, said the mixing tool displacement device has a telescoping device, or is formed by said telescoping device, wherein said at least one mixing tool is displaceable by means of said telescoping device between the at least one mixing tool use position and the mixing tool non-use position, as viewed in a telescopic axis direction.

2. The construction site mixing machine according to claim 1, wherein said telescoping device has at least two telescoping elements which are telescopable relative to one another in the telescopic axis direction with respect to said telescoping device.

3. The construction site mixing machine according to claim 2, wherein said at least two telescoping elements include a lower telescoping element which is lower in the telescopic axis direction and is adjoined, upwards in the telescopic axis direction, by at least one upper telescoping element which is displaceable relative thereto and on which said mixing tool drive unit is disposed.

4. The construction site mixing machine according to claim 1,
wherein by means of said mixing tool displacement device said at least one mixing tool, which is actuatable by means of said mixing tool drive unit, is displaced between the at least one mixing tool use position, in which said at least one mixing tool is accommodated in said receiving space in an operational state, and the mixing tool non-use position, in which said at least one mixing tool is not in the operational state, wherein said at least one mixing tool is received in said receiving space in an operational position, and in the mixing tool non-use position in which said at least one mixing tool is not in the at least one mixing tool use position;
further comprising a control unit for electronically controlling an activation and deactivation of said mixing tool drive unit;
further comprising an actuation device, by means of said actuation device said control unit is activatable and, if necessary, deactivatable; and
wherein said control unit has a safety function and/or safety device which is configured to enable operation of said mixing tool drive unit when said actuation device is activated, if said at least one mixing tool is in the at least one mixing tool use position, or to block said actuation device if said at least one mixing tool is not in the at least one mixing tool use position.

5. The construction site mixing machine according to claim 4, further comprising:
a mixing container holder for holding said upwardly open mixing container, said mixing container holder having a support surface on which said upwardly open mixing container is settable, and/or said mixing container holder has a holding device which is configured to hold said upwardly open mixing container detachably on said mixing container holder; and
at least one engagement element disposed which, in a position of use of said upwardly open mixing container, interacts with at least one counter-engagement element formed on said upwardly open mixing container.

6. The construction site mixing machine according to claim 5,
further comprising a mixing container drive unit; and
wherein said mixing container holder has a rotatably mounted receiving element which receives said upwardly open mixing container and is coupled to said mixing container drive unit so that said rotatably mounted receiving element (9 is drivable in rotation, so that said upwardly open mixing container is rotatable together with said rotatably mounted receiving element during a mixing process.

7. The construction site mixing machine according to claim 6, wherein said control unit electronically controls the activation and deactivation of said mixing container drive unit, said safety function and/or safety device is configured to enable the operation of said mixing container drive unit when said actuation device is activated, if said at least one mixing tool is in the at least one mixing tool use position, or blocking said activation device if said at least one mixing tool is not in the at least one mixing tool use position.

8. The construction site mixing machine according to claim 5, wherein said mixing container holder has or forms a housing and/or frame part of the construction site mixing machine disposed on a floor side with respect to a vertical axis direction.

9. The construction site mixing machine according to claim 8, wherein said telescoping device is connected directly or indirectly to said mixing container holder having said housing and/or said frame part.

10. The construction site mixing machine according to claim 3, further comprising a guided displacement device which is configured such that when said upper telescoping element is lowered, said guided displacement device blocking a rotation of said upper telescoping element relative to said lower telescoping element and releasing a positively guided linear transfer of said at least one mixing tool into the at least one mixing tool use position.

11. The construction site mixing machine according to claim 3, wherein:
said telescoping device has at least one pretensioning element;
by means of said at least one pretensioning element said telescoping device is pretensionable into an extended position; and
against a pretensioning force of said at least one pretensioning element said telescoping device is displaceable into a collapsed position.

12. The construction site mixing machine according to claim 11, wherein said upper telescoping element, in the extended position of said telescoping device, is rotatable or pivotable relative to said lower telescoping element and in a horizontal plane about a longitudinal axis of said telescoping device, such that said at least one mixing tool, in the extended position of said telescoping device, is rotatable or pivotable by means of said upper telescoping element in a plane above the longitudinal axis of said telescoping device such that, in the extended position of said telescoping device, said at least one mixing tool is pivotable by means of said upper telescoping element in a horizontal plane lying above an upper edge of said upwardly open mixing container into a mixing tool insertion position in which said at least one mixing tool is disposed directly above an outlet opening of said upwardly open mixing container and is prepared for transfer into the at least one mixing tool use position.

13. The construction site mixing machine according to claim 12, wherein in the extended position of said telescoping device, said at least one mixing tool is pivotable away from the mixing tool insertion position into a filling position by means of said upper telescoping element in the horizontal plane lying above said upper edge of said upwardly open mixing container, such that said at least one mixing tool is disposed laterally outside said upwardly open mixing container and/or that said outlet opening of said upwardly open mixing container is exposed for filling.

14. The construction site mixing machine according to claim 12, further comprising a swivel angle limiting device, by means of said swivel angle limiting device a swivel angle of said upper telescoping element relative to said lower telescoping element and thus two maximum pivot positions are limited, it being provided that a first maximum pivot position corresponds to the mixing tool insertion position, in which said at least one mixing tool is located directly above said outlet opening of said upwardly open mixing container, and that a second maximum pivot position is a pivot position in which said at least one mixing tool is disposed laterally outside said upwardly open mixing container and/or is pivoted outwards by at least 60° away from the mixing tool insertion position.

15. The construction site mixing machine according to claim 12, further comprising a locking mechanism configured to releasably lock a pivoting back of said upper telescopic element pivoted from the mixing tool insertion position in a direction of a filling position, in dependence on a predetermined pivoting path.

16. The construction site mixing machine according to claim 3, further comprising a suction device disposed on said upper telescoping element, by means of said suction device a suction material accumulating in a region of an outlet opening of said upwardly open mixing container is suckable off.

17. The construction site mixing machine according to claim 3, wherein said telescoping device has a guided displacement device which releases a lowering of said upper telescoping element only in a mixing tool insertion position, in which said at least one mixing tool is disposed directly above an outlet opening of said upwardly open mixing container.

18. The construction site mixing machine according to claim 1, further comprising a locking mechanism, by means of said locking mechanism said telescoping device is releasably locked in the at least one mixing tool use position of said at least one mixing tool.

19. The construction site mixing machine according to claim 18, further comprising an elastic pretensioning element, wherein said telescoping device is displaceable in an unlocked state by means of said elastic pretensioning element in a direction of an extended position.

20. The construction site mixing machine according to claim 4, wherein said safety function and/or safety device has a monitoring device which is coupled to said control unit in a signal-transmitting manner and is configured to detect the at least one mixing tool use position of said at least one mixing tool, to detect an operation of said mixing tool drive device, to detect at least the at least one mixing tool use position of said at least one mixing tool, and to enable operation of said mixing tool drive unit and/or said mixing container drive unit, when said actuation device is activated, only when said at least one mixing tool is in the at least one mixing tool use position.

21. The construction site mixing machine according to claim 20, further comprising a bridging device coupled to said control unit in the signal-transmitting manner and is configured to activate said mixing tool drive unit when said bridging device is actuated and/or when said actuation device is activated, provided that said at least one mixing tool is not in the at least one mixing tool use position, or to lock it when said at least one mixing tool is in the at least one mixing tool use position, so that said mixing tool drive unit is not activatable by means of said bridging device in the at least one tool use position.

22. The construction site mixing machine according to claim 1, wherein said telescoping device has a cover element which is displaceable together with said at least one mixing tool and, in the at least one mixing tool use position, closes an outlet opening of said upwardly open mixing container at least in certain regions.

23. The construction site mixing machine according to claim 3, further comprising a drive unit housing disposed on said upper telescoping element, wherein said mixing tool drive unit is accommodated in said drive unit housing.

24. A construction site mixing machine for mixing mixing materials, comprising:
an upwardly open mixing container having a receiving space and configured to receive a mixing material in said receiving space;
a mixing tool drive unit;
at least one mixing tool being drivable in rotation by means of said mixing tool drive unit, said at least one mixing tool configured to be received in a mixing tool use position in said receiving space;
a mixing container drive unit;
a rotatably mounted mixing container holder for holding said upwardly open mixing container and drivable in rotation by said mixing container drive unit, so that said upwardly open mixing container is rotatable during a mixing process; and
a control unit electronically controlling an activation and deactivation of said mixing tool drive unit and said mixing container drive unit, said control unit configured to drive said upwardly open mixing container by means of said mixing container drive unit in an opposite direction to said at least one mixing tool which is drivable in rotation by means of said mixing tool drive unit, and/or said control unit has a timer function by means of which an operating time of said mixing tool drive unit and/or of said mixing container drive unit is settable and/or controllable.

25. The construction site mixing machine according to claim 24, wherein said control unit is configured to drive said upwardly open mixing container by means of said mixing container drive unit at least intermittently in a first direction of rotation and/or to drive said at least one mixing tool by means of said mixing tool drive unit at least intermittently in a second direction of rotation opposite to the first direction of rotation.

26. The construction site mixing machine according to claim 24, further comprising an actuation device, by means of said actuation device said control unit is activatable and, if necessary, deactivatable.

27. The construction site mixing machine according to claim 26, further comprising a manual agitator having a handle unit and a drive unit housing and in said drive unit housing said mixing tool drive unit is accommodated, wherein said control unit, said at least one mixing tool and said mixing tool drive unit are part of said manual agitator.

28. The construction site mixing machine according to claim 26, wherein said actuation device is disposed on said handle device.

29. The construction site mixing machine according to claim 27, wherein said actuation device has a throttle switch as a manual switch or is formed by said throttle switch configured as the manual switch.

30. The construction site mixing machine according to claim 29, wherein said actuation device has a mechanical actuation lever which interacts with said throttle switch, and said mechanical actuation lever is configured to mechanically actuate said throttle switch in dependence on a position of said at least one mixing tool.

31. The construction site mixing machine according to claim 30, further comprising:
a mixing tool displacement device, said mechanical actuation lever is disposed on said mixing tool displacement device; and
a stop element disposed on said mixing tool displacement device, said mechanical actuation lever is assigned said stop element disposed on said mixing tool displacement device, against said stop element said actuation lever comes to a stop after a defined displacement path when said at least one mixing tool is displaced into the mixing tool use position, so that said mechanical actuation lever is actuated during a further displacement of said at least one mixing tool into a position of use of said at least one mixing tool and actuates said throttle switch.

32. The construction site mixing machine according to claim 24, wherein said control unit has a timer device with a timer function, said timer device is configured to count down an adjustable and/or predeterminable period of time and to automatically deactivate said mixing tool drive unit and/or said mixing container drive unit after the adjustable and/or predeterminable period of time has elapsed.

33. The construction site mixing machine according to claim 24, further comprising a time selection device, said control unit is coupled to said time selection device and by means of said time selection device an operating time of said mixing tool drive unit and/or said mixing container drive unit is presettable.

34. The construction site mixing machine according to claim 24, wherein said control unit is configured to activate and optionally deactivate said mixing tool drive unit and said mixing container drive unit at a same time or with a time delay.

35. The construction site mixing machine according to claim 24, wherein said control unit has a safety function and/or safety device which is configured to release an operation of said mixing container drive unit and/or said mixing tool drive unit when said at least one mixing tool is in the mixing tool use position, when said at least one mixing tool is in the mixing tool use position, or to block or to stop it when said at least one mixing tool is not in the operational mixing tool use position.

36. The construction site mixing machine according to claim 35, wherein said safety function and/or safety device has a monitoring device which is coupled to said control unit in a signal-transmitting manner.

37. The construction site mixing machine according to claim 24, further comprising a mixing tool displacement device, by means of said mixing tool displacement device said the at least one mixing tool, which is drivable in rotation by means of said mixing tool drive unit, is displaceable between at least one mixing tool use position, in which said at least one mixing tool is accommodated in said receiving space, and a mixing tool non-use position, in which said at least one mixing tool is not disposed in any mixing tool use position.

38. The construction site mixing machine according to claim 37, wherein:
said mixing tool displacement device has a telescoping device, or is formed by said telescoping device; and
said at least one mixing tool is displaceable between the at least one mixing tool use position and the mixing tool non-use position by means of said telescoping device as viewed in a telescopic axis direction.

39. The construction site mixing machine according to claim 24, wherein said mixing container holder has a rotatably mounted receiving element which receives said upwardly open mixing container and is coupled to said mixing container drive unit such that said rotatably mounted receiving element is drivable in rotation.

40. The construction site mixing machine according to claim 39, wherein said rotatably mounted receiving element has a support surface on which said upwardly open mixing container is placeable for receiving said upwardly open mixing container in said mixing container holder, and/or in that said mixing container holder has a holding device configured to detachably hold said upwardly open mixing container.

41. A method for operating a construction site mixing machine, which comprises the steps of:
providing an upwardly open mixing container being configured to receive a mixing material in a receiving space of the upwardly open mixing container;
providing a mixing tool displacement device, by means of the mixing tool displacement device at least one mixing tool, which is actuatable by means of a mixing tool drive unit is displaceable between at least one mixing tool use position, in which the at least one mixing tool is accommodated in the receiving space, and a mixing tool non-use position, in which the at least one mixing tool is not located in any mixing tool use position, the mixing tool displacement device having a telescoping device or is formed by the telescoping device, wherein the at least one mixing tool is displaceable by means of the telescoping device between the at least one mixing tool use position and the mixing tool non-use position, as viewed in a telescopic axis direction; and/or
providing a controller electronically controlling an activation and deactivation of the mixing tool drive unit, and an actuation device, by means of which the controller is activatable and, if necessary, deactivatable, the controller having a safety function and/or a safety device which enables operation of the mixing tool drive unit when the actuation device is activated if the at least one mixing tool is in the mixing tool use position, or blocks operation of the construction site mixing machine if the at least one mixing tool is not in the mixing tool use position.

42. A method for operating a construction site mixing machine, which comprises the steps of:
providing an upwardly open mixing container being configured to receive a mixing material in a receiving space of the upwardly open mixing container;
providing at least one mixing tool being drivable in rotation by means of a mixing tool drive unit, the at least one mixing tool being configured to be received in a mixing tool use position in the receiving space;
providing a rotatably mounted mixing container holder for holding the upwardly open mixing container and is drivable in rotation by a mixing container drive unit, so that the upwardly open mixing container is rotatable during a mixing process;
providing a controller for electronically controlling an activation and deactivation of the mixing tool drive unit and the mixing container drive unit, in that the controller is configured to drive the upwardly open mixing container by means of the mixing container drive unit in an opposite direction to the at least one mixing tool which is drivable in rotation by means of the mixing tool drive unit, and/or the controller has a timer function by means of which an operating time of the mixing tool drive unit and/or the mixing container drive unit is settable and/or controllable.
